(19) United States
(12) Patent Application Publication
(10) Pub. No.: US 2002/0040253 A1
(43) Pub. Date: Apr. 4, 2002

(54) METHOD AND APPARATUS FOR ILLUSTRATING U.S-STYLE FOOTBALL GAMES

(76) Inventors: RICHARD MCNALLY, CAMBRIDGE, MA (US); PETER J. MCNALLY, TORONTO (CA); GEORGE DRISCOLL, FLOWER MOUND, TX (US)

Correspondence Address: SHLESINGER ARKWRIGHT & GARVEY LLP, 3000 SOUTH EADS STREET, ARLINGTON, VA, 22202, US

(21) Appl. No.: 09/162,402

(22) Filed: Sep. 28, 1998

Related U.S. Application Data
(60) Provisional application No. 60/071,147, filed on Jan. 12, 1998.

(51) Int. Cl. A63F 13/00

(52) U.S. Cl. 700/91; 463/1

(57) ABSTRACT

In one embodiment, a method for rendering a diagram representing a football game between two teams involves rendering a plurality of symbols on a display and/or a substrate of a printing device. According to the method, in response to information input to a processor regarding at least two plays in a drive by one of the two teams, the plurality of symbols are rendered on the display and/or the substrate of the printing device along a path representing at least a portion of the drive by the one of the two teams. The plurality of symbols represent the at least two plays such that each of the at least two plays can be distinguished from the other of the at least two plays. In another embodiment, a method for rendering a diagram representing a football game between two teams involves rendering a single representation of a football field on which the game was played on a display and/or a substrate of a printing device. In response to information input by a user regarding drives of the football game, a plurality of symbols are rendered on the display and/or the substrate within the single representation of the football field, the symbols representing all drives that occurred during at least a half of the football game.

### BACKGROUND

U.S.-style football (“football”) is a popular sport in many countries, including, for example, the United States (U.S.), Canada, and multiple European countries. In the U.S., football ranks as one of the most popular and growing sports among athletes and spectators of all ages. Many high schools, colleges and universities sponsor football teams in an effort to foster school spirit, to raise revenue, and to draw attention to school names. Football is also played by professional teams in many countries. The most popular and successful league of professional football teams in the U.S. is the National Football League (NFL). Another league of professional football teams is the World Football League, which involves teams from several European countries.

In a football game, two teams compete with one another on a rectangular field of grass or artificial turf (i.e., a football field). The general object of a football game is for each team to attempt to move an oblong-shaped, leather-covered ball (i.e., a football), during a series of plays, towards and into an “end zone” of the football field defended by the opposing team. A team in possession of the football may move the football on the field by running with it (i.e., a running play), throwing it (i.e., a passing play), kicking it from a stationary position on the field (i.e., a kick), or by kicking it while in flight after releasing it in the air (i.e., a punt).

During each play, the team that is not in possession of the football tries to stop the other team from advancing toward or entering the end zone it is defending. The precise characteristics and rules of a football game may vary from league to league and from country to country. The following description of a typical football game is provided only as an illustrative example of the characteristics and rules that may govern a football game in the U.S.

In a typical football game, eleven players from each team (a total of twenty-two players) are present on the field during each play of the game. A football field is typically one-hundred and sixty yards wide and one-hundred yards long (excluding a ten-yard-deep end zone abutting each end of the field), and is marked by lines across its width at five-yard intervals known as yard lines. The yard lines separating the end zones from the football field are called goal lines and are typically marked with the letter “G”. The yard lines between the two goal lines are generally marked at ten yard intervals with the numerals “10,” “20,” “30,” “40,” “50,” “40,” “30,” “20,” “10,” with the numeral “50” marking the mid-field yard line directly between the two goal lines.

A regulation football game lasts for one hour. The play time of a football game is divided into two halves, each half being divided into two fifteen-minute quarters. The two teams defend end zones at opposite ends of the football field during each of the four quarters. The teams switch sides at the end of each quarter so that each of them defends a different end zone during each quarter of play. The end zone defended by each of the teams during a particular quarter is considered to be that team's end zone during the quarter.

Each half of a football game begins with one team (the kicking team) kicking the football (i.e., “kicking off”) to the other team (the receiving team). The determination of which team will off and which team will receive is generally made by tossing a coin, with the winner of the coin toss selecting whether his team will kick off or receive to begin the first half of play. The loser of the opening coin toss selects whether his team will kickoff or receive the football to begin the second half of play. The receiving team gains possession of the football at the beginning of each half. During the football game, the team in possession of the football attempts to move the football toward and into the other teams's end zone. The team in possession of the football is called the offense, and the team not in possession of the football is called the defense.

A football game can be supervised by one or more so-called “officials,” who's job it is to make sure that the rules of the game are followed correctly. When, during a football game, one of the two teams engages in prohibited conduct, that team may be penalized for such conduct. Typically, a penalty results in the position of the football being moved by an official a predetermined number of yards toward the end zone of the penalized team.

Each time the forward motion of the offense is stopped (e.g., a player is tackled, an incomplete pass is thrown, etc.), a so-called “down” occurs. The offense is given four downs (or plays) to move the ball ten yards closer to the defense's end zone. Each time the ball is moved ten yards, the offense is given another four downs to move the ball yet another ten yards. The yard line at which each down begins is called the “line of scrimmage” for that down. If the offense fails to move the ball ten yards during a set of four downs, the defense gains possession of the football and becomes the offense. After failing to move the ball ten yards during three downs, the offense may opt to kick the ball towards the defense's end zone (i.e., it may punt the football), so as to force the defense to start its next offensive drive from a field position that is as close as possible to its own end zone. When the offense punts the football, the defense gains possession of the football at the moment the football crosses the line of scrimmage.

The defense may also take over possession of the football in other ways. For example, the defense may gain possession by intercepting the football during a forward pass by the offense (i.e., an interception), or by recovering the football after an offensive player has dropped it during a running play or dropped it during a passing play after having caught the football (i.e., recovering a fumble).

Each set of plays during which one team retains exclusive possession of the football is called a drive. A new drive begins each time one team gains possession of the football from the other. In a so-called “scoring drive,” the offense either moves the ball into the defense's end zone (thereby scoring a “touchdown”) or kicks the football through a goal post located in the defense's end zone (thereby scoring a “field goal”). The offense receives six points for scoring a touchdown and three points for scoring a field goal. When the offense misses a field goal attempt, the defense gains possession of the football at the location from which the ball was kicked. When the offense successfully kicks a field goal, the scoring team kicks off to the non-scoring team.

After scoring a touchdown, the offense is given an opportunity to kick the football (from the defense's two-yard line) though the defense's goal posts, thereby scoring a so-called “extra point.” The offense receives one point for scoring an extra point in this manner. Alternatively, after scoring a touchdown, the offense may attempt to score two extra points by moving the football (during a single running or passing play) from the defense's two-yard line into the defense's end zone. After an extra point attempt, whether or not successful, and assuming that a penalty has not occurred, the scoring team kicks off from its thirty-yard line to the non-scoring team.

Additionally, the defensive team may score two points by tackling one of the offense's players in the offense's end zone. Such a play is called a “safety.” After a safety, the non-scoring team kicks or punts the football from its twenty-yard line to the scoring team (i.e., the scored upon team takes a “free kick”).

For additional information regarding the sport of football, reference may be made to a rule book prepared by the NFL entitled Official Rules of the NFL (Chicago: Triumph, 1995), which is incorporated herein by reference.

Football games are commonly reported by the media. The most common types of media that report football games include television broadcasts, newspapers, and magazines. To convey information regarding a single play of a football game using these media, it is known to render symbols (e.g., “X's,” “O's” solid lines, and directional arrows) on a grid representing a football field. The grid generally is divided into five or ten-yard segments and has proportions similar to those of an actual football field. The position of each “X” and “O” on the grid represents the location one of the twenty-two players on the football field when the represented play began, the “X's” representing the players on one team and the “O's” representing the players on the other. The solid lines and directional arrows are used to represent the route followed by one or more of the twenty-two players during the represented play.

It is also known to draw solid lines marked with directional arrows on a grid representing a football field to indicate the lengthwise distances traversed between the two end zones during drives made by each of the two football teams. Grids marked in this manner are called “drive charts.” Each such solid line begins at a position on the grid corresponding to a yard line on the football field at which the represented drive began and ends at a position corresponding to a yard line at which the drive ended. It is known to place numbers on or near each line to indicate the total number of plays that occurred during the represented drive, the total number of yards gained by the drive, and the score change, if any, resulting from the drive. Commonly, four separate representations of the football field (one for each quarter) are used to represent all of the drives of a football game using this technique.

### SUMMARY

According to one aspect of the present invention, an article of manufacture for conveying information regarding a football game between two teams includes a substrate and a plurality of symbols rendered thereon. The plurality of symbols are rendered along a path representing at least a portion of a drive by one of the two teams, and represent at least two plays that occurred during the drive such that each of the at least two plays can be distinguished from the other of the at least two plays.

According to another aspect of the invention, an apparatus for producing an article of manufacture that conveys information regarding a football game between two teams includes a printing device. The printing device is configured to render a plurality of symbols on a substrate along a path representing at least a portion of a drive by one of the two teams, the symbols representing at least two plays that occurred during the drive such that each of the at least two plays can be distinguished from the other of the at least two plays.

According to another aspect of the invention, a computer-implemented method for rendering a diagram representing a football game between two teams involves rendering a plurality of symbols on a display and/or a substrate of a printing device. According to the method, in response to information input to a processor regarding at least two plays in a drive by one of the two teams, the plurality of symbols are rendered on the display and/or the substrate of the printing device along a path representing at least a portion of the drive by the one of the two teams. The plurality of symbols represent the at least two plays such that each of the at least two plays can be distinguished from the other of the at least two plays.

According to another aspect of the invention, a computer-readable medium for use with a processor has a plurality of instructions stored thereon which, when executed by the processor, cause the processor to perform a step of: (a) in response to information input to the processor regarding at least two plays in a drive by a football team, causing a plurality of symbols to be rendered on a display and/or a substrate of a printing device. The plurality of symbols are caused to be rendered along a path representing at least a portion of the drive by the one of the two teams such that each of the at least two plays can be distinguished from the other of the at least two plays.

According to another aspect of the invention, an apparatus for rendering a diagram representing a football game between two teams includes means for rendering a plurality of symbols on a display and/or a substrate of a printing device, the plurality of symbols being rendered along a path representing at least a portion of a drive by one of the two teams. The apparatus also includes means for representing at least two plays in the drive such that each of the plays can be distinguished from the other.

According to another aspect, a computer-implemented method for rendering a diagram representing a football game between two teams involves rendering a single representation of a football field on which the game was played on a display and/or a substrate of a printing device. In response to information input by a user regarding drives of the football game, a plurality of symbols are rendered on the display and/or the substrate within the single representation of the football field, the symbols representing all drives that occurred during at least a half of the football game.

### BRIEF DESCRIPTION OF THE DRAWINGS

FIG. 1 is a diagram showing an example of how a display medium may appear according to one embodiment of the present invention;

FIG. 2 is a diagram showing an example of how an entire football game may be represented on the field portion of the display medium shown in FIG. 1;

FIG. 3 is a diagram showing an example of how a legend-portion of the display medium shown in FIG. 1 may appear according to one embodiment of the invention;

FIG. 4 is a block diagram showing an example of a computer system with which an embodiment of the present invention may be employed;

FIG. 5 is a flowchart showing an example of a computer-implemented method for representing a football game on an illustration of a football field according to one embodiment of the invention;

FIGS. 6-15 are diagrams showing how a computer display may appear when the method of FIG. 5 is executed by a computer; and

FIGS. 16-18 are diagrams showing examples of how the display shown in FIG. 1 may appear according to alternative embodiments of the invention.

### DETAILED DESCRIPTION

Using the prior art illustration technique discussed above in which symbols (e.g., “X's,” “O's,” solid lines, and directional arrows) are rendered on a grid representing a football field, it is difficult, if not impossible, to represent more than one play of the game on the same grid in a manner that can be readily understood by a person viewing it. If two or more plays were represented on the same grid, the symbols (e.g., “X's” and “O's”) from the various plays would intermingle and/or overlap, and the solid lines would intersect one another, so as to render the illustration virtually impossible to interpret.

Additionally, using the prior art illustration technique discussed above in which solid lines (representing lengths and directions of drives) are rendered on each of four separate representations of a football field, because each drive is represented only by a single, solid line, no information is conveyed regarding the nature of the individual plays that occurred during the represented drive. The person viewing the representations is therefore unable to ascertain what types of plays occurred during each drive, and how each of the constituent plays of a given drive contributed to the total yardage gained or lost during that drive. Further, the four separate representations of the playing field used in accordance with this technique present a total of eight side lines to the viewer, and three columns of empty space intervene among the four representations of the field. These multiple side lines and unavoidable empty columns of space contribute to the graphic clutter of the presentation, and result in a fragmented view of the game as a whole.

In one embodiment of the invention, a drive of a football game is illustrated on a grid representing a football field by rendering symbols on the grid that represent the changes in the position of the football lengthwise along the field (i.e., between the end zones) as a result of each of the individual plays in the drive. In one embodiment, the symbols are rendered on the grid so as not to represent the sideways changes in the position football (i.e., between the sidelines) as a result of each play, thereby simplifying the representation and making it easy to interpret.

In one embodiment, different types of lines (e.g., solid, dashed, and dotted lines) are used to represent different types of plays (e.g., running plays, passing or kicking plays, and penalties), and different symbols (e.g., filled dots, unfilled dots, hatch marks) are used to indicate the points or yard lines on the football field at which each represented play began and ended, and to convey information regarding the result of each play. In one embodiment, the different symbols may be color coded to help differentiate them, or color coded symbols may be used in lieu of using different types of symbols. Additional symbols may also be placed near each line segment representing a play to convey additional information about that play. For example, the player responsible for moving the ball during each of the illustrated plays, or the fact that a particular play resulted in a touchdown, fieldgoal, penalty, etc., may be indicated on the grid by rendering one or more appropriate symbols near, or attached to, the line segment representing the play.

In one embodiment, several line segments representing consecutive plays in a single drive are joined end-to-end to form what is called a “drive line” which represents the total lengthwise change in the ball's field position during the drive. The drive line may be made to continue along a linear path lengthwise on the grid representing the football field unless no yardage was gained or a loss of yardage or penalty occurred during the play. In such cases, the portion of the drive line representing the play that resulted in no yardage gain, or a loss of yardage, may be made to extend sideways, or diagonally, on the grid so that the drive line does not overlap itself. Every play in a given drive may be represented using a drive line constructed in this manner.

Because, in one embodiment, the symbols do not represent sideways changes in field position of the football, multiple drive lines may be located side-by-side on a single grid so that multiple drives may be represented simultaneously thereon. Therefore, not only may each play of a single drive be represented on a single grid, but every drive of every play of a quarter, a half, or an entire football game may be represented on a single grid in accordance with different aspects of the invention.

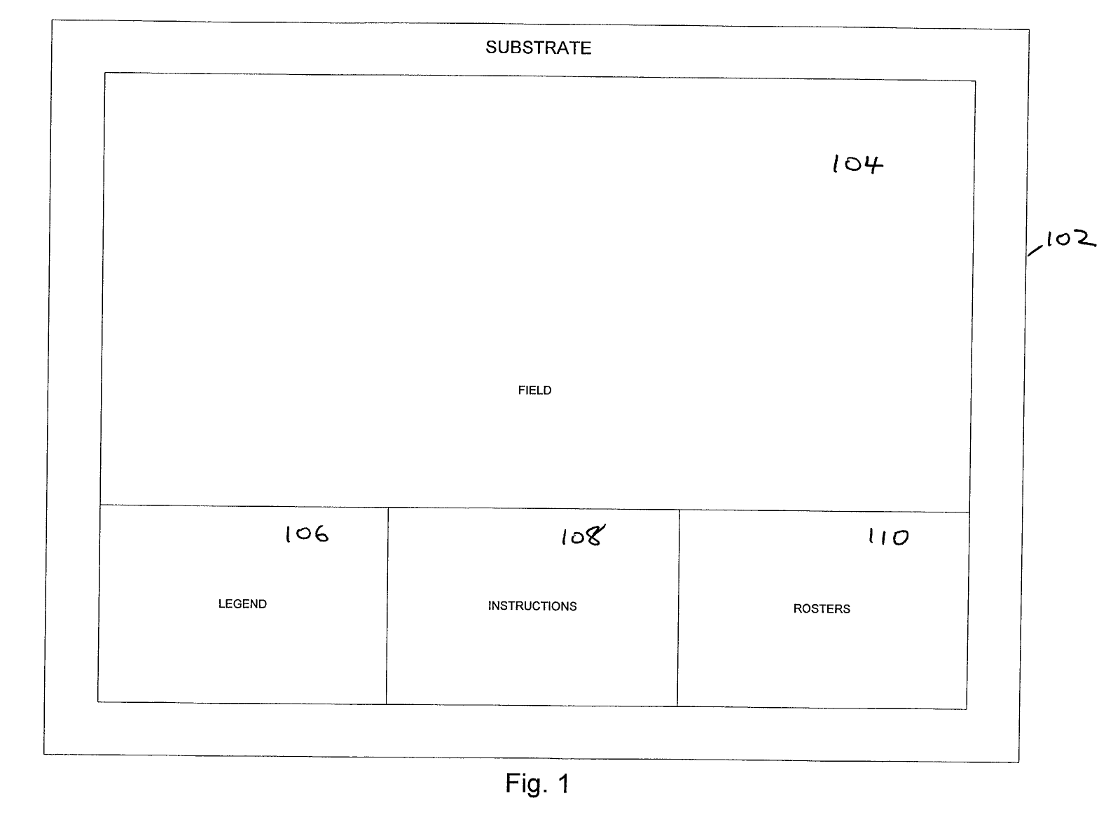

FIG. 1 shows a display medium 102 on which symbols may be rendered in accordance with one embodiment of the present invention. The display medium may be any medium on which symbols can be rendered, and the invention is not limited to any particular type of medium. In one embodiment, for example, the display medium 102 includes a substrate on which symbols may be printed or embossed by computer, printer, hand, etc. In another embodiment, the display medium includes a computer display screen on which symbols may be rendered. When the display medium 102 includes a substrate, the substrate may be formed of a contiguous piece of paper material or any other material suitable for receiving printing material (e.g., ink) thereon. In such an embodiment, the substrate may be, for example, approximately twelve inches wide and eleven inches in length. It should be appreciated, however, that the invention is not limited to a substrate formed of any particular type of material or to a substrate of any particular size. When the display medium 102 constitutes a computer display screen, the computer display screen may be any display screen suitable for rendering the necessary images thereon. The invention is not limited to any particular type computer or computer display.

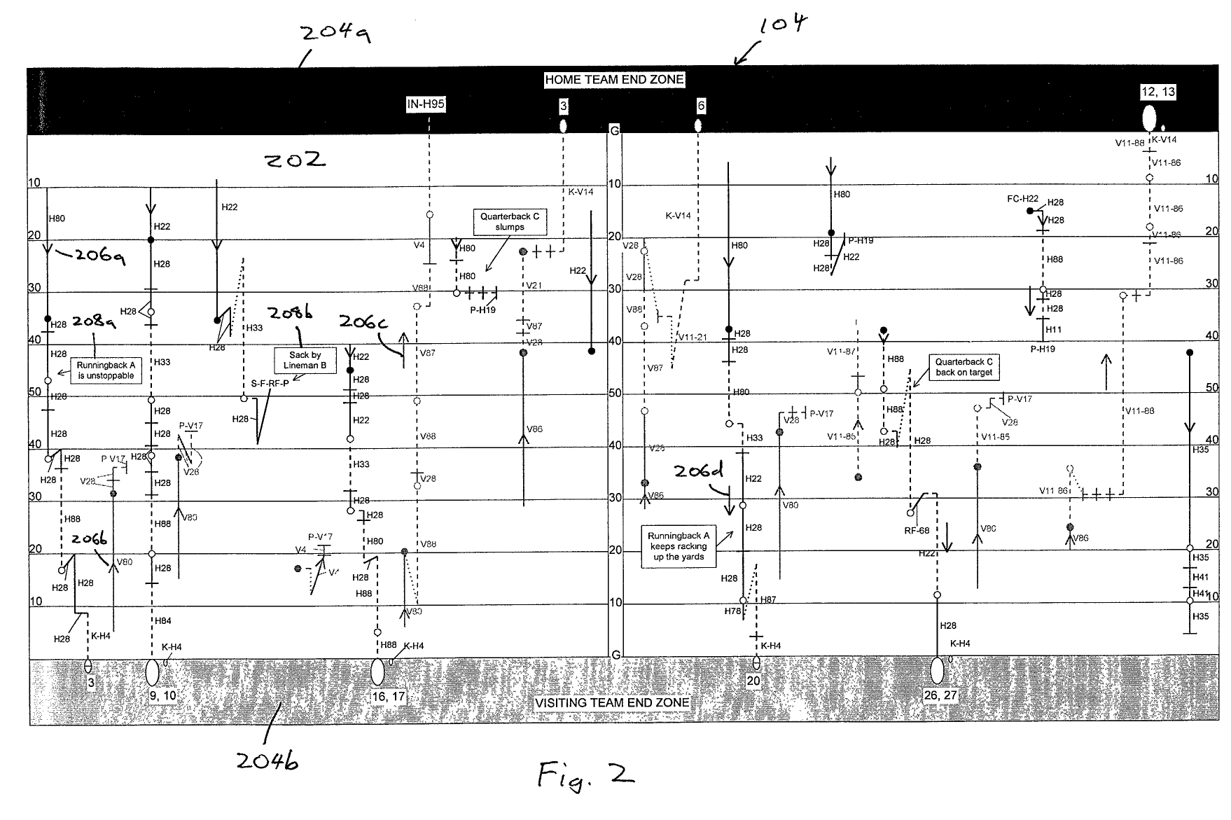

As shown in FIG. 1, the display medium 102 may be divided into several portions: a grid or field portion 104, a legend portion 106, an instructions portion 108, and a roster portion 110. The field portion 104 is a section of the display medium 102 on which lines corresponding to the yard lines of a football field may be drawn, and on which symbols may be included to represent one or more plays of a football game. One example of how the field portion 104 may appear in connection with an embodiment of the invention is shown in FIG. 2.

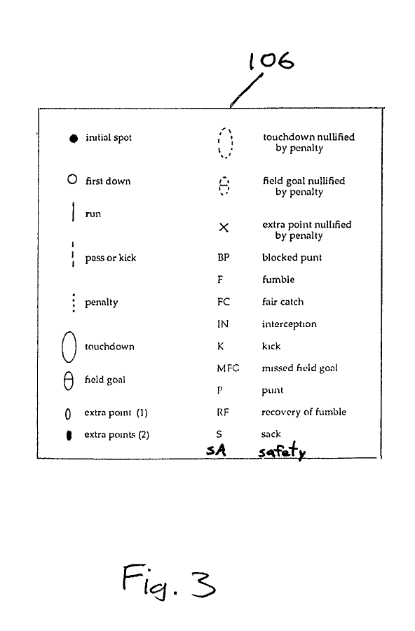

The individual plays in a football game may be represented on the field portion 104 using any of numerous symbols, and the invention is not limited to the use of any particular symbols. Examples of symbols that may be used to represent a football game in connection with an embodiment of the invention are shown in FIG. 3. The symbols identified in the legend portion 106 shown in FIG. 3 correspond to the symbols included on the field portion 104 shown in FIG. 2. As shown in FIG. 3, the legend portion 106 may include information regarding the symbols that are used to represent particular types of plays, as well as the possible results of such plays.

The roster portion 110 (FIG. 1) may provide a listing of all of the players on each of the teams that played in the football game represented on the field portion 104. Alternatively, those players responsible for moving the football during one or more plays represented on the field portion 104, those players who made noteworthy plays during the game, and/or those players that actually played in the game, may be listed on the roster portion 110. It should be appreciated that the invention is not limited to any particular manner of listing players (i.e., names, numbers, etc.) or any particular criteria for determining which players are listed.

The instructions portion 108 (FIG. 1) may provide instructions regarding how to interpret the symbols and information provided on the other portions of the display medium 102. It should be appreciated that the arrangement of each of the portions on the display medium 102 may be different than that shown in FIG. 1, and that the invention is not limited to any particular arrangement. It should also be understood that, in alternative embodiments, the display medium 102 may include fewer, additional or different portions than those shown in the FIG. 1 embodiment, and that the invention is not limited to the particular portions shown in this example.

FIG. 2 shows an example of how the field portion 104 of the display medium 102 may appear when an entire football game is rendered thereon. In the example shown, the field portion 104 includes symbols thereon which represent a football game between a home team (HOME) and a visiting team (VISITORS). To represent the football game, symbols are rendered on a grid 202 which is divided into ten segments corresponding to the marked yard lines, i.e., the ten-yard segments, of a football field. At the top and bottom of the grid 202 are the end zones 204a-b of the opposing teams. Each of the symbols included on the field portion 104 conveys information regarding a particular play in the football game illustrated thereby. In one embodiment, the display medium 102 illustrates, simultaneously and without exception, every play that occurred during a completed football game, or that has occurred during a game in progress.

The drives by the two teams may be distinguished in any of numerous ways, and the invention is not limited to the use of any particular technique for distinguishing them. In the FIG. 2 embodiment, for example, drives by the home team (HOME) are represented using solid, black lines, and the drives by the visiting team (VISITORS) are represented using lighter-colored, grey lines. In alternative embodiments, the drives of the two teams may be represented using lines of the same color and weight, and may be distinguished only by the direction of the drives, as indicated, for example, by arrows 206a-206d in FIG. 2. In embodiments of the invention that employ color renditions, the drive lines may be rendered on the display medium 102 in contrasting colors to enhance legibility, or to distinguish teams, plays, drives, etc.

In the example embodiment shown in FIG. 2 (as indicated in the legend portion 106 shown in FIG. 3), an individual running play is represented on the field portion 104 of the display medium 102 by a solid line, a pass or kick is represented by a dashed line, a penalty is represented by a dotted line, a fair catch is represented by a symbol “FC,” and a safety (not shown in FIG. 2) is represented by a symbol “SA.” Rather than representing all twenty-two players for each play of the football game, the FIG. 2 embodiment identifies only one player for each play, i.e., the player responsible for moving the ball on the football field during the play. In the FIG. 2 embodiment, the player number (e.g., H80 or V80) at the midpoint of each line segment representing a running, passing, or kicking play is the number of the player (e.g., a runner, receiver, or kicker) responsible for the movement of the ball on the field during that play. If a player other than the starting quarterback throws a pass, the passer's number, as well as the receiver's number, is indicated at the midpoint of the dashed line segment representing the pass, with the passer's number preceding the receiver's number and being separated therefrom by a hyphen. In the FIG. 2 embodiment, a punt is represented by placing the symbol “P” next to a location on the grid 202 corresponding to a position on the football field from which the ball was punted. The distance traversed by a punt may be determined by comparing the location on the grid 202 at which the punt symbol “P” was placed and the location on the grid 202 at which the next drive line of the opposing team begins.

The FIG. 2 diagram does not show the actual route each player followed while running with or otherwise causing the football to move on the field. Rather, each line segment in FIG. 2 is oriented either: (A) vertically on the grid 202 (i.e., between the end zones 204a-b) to indicate how far the player advanced with the ball during a given play, or how much yardage the player lost, (B) horizontally on the grid 202 to indicate that the player was held for no gain or failed to catch a pass, or (C) diagonally on a grid 202 to prevent the line segment for a play from overlapping with a line segment from a prior play, for example, when a play or penalty occurred that resulted in a loss of yardage for the team in possession of the football.

In the example embodiment shown, the line segments representing the individual plays executed by each team while that team was in possession of the football are joined end-to-end to form so-called “drive lines.” Each drive line represents the progress (if any) made by the offense toward the defense's end zone during a particular drive. Each period of time when one team was in exclusive possession of the football is indicated by a separate drive line. In the FIG. 2 embodiment, each team's drive lines do not change direction at the end of each quarter. Thus, the direction of each team's drive lines is consistent throughout the entire game. This unidirectional orientation of each team's drive lines facilitates a comparison of the performances of the two teams, and permits a viewer to obtain a better understanding of each team's performance over the entire course of the game, i.e., it gives the viewer a better understanding of the game as a whole.

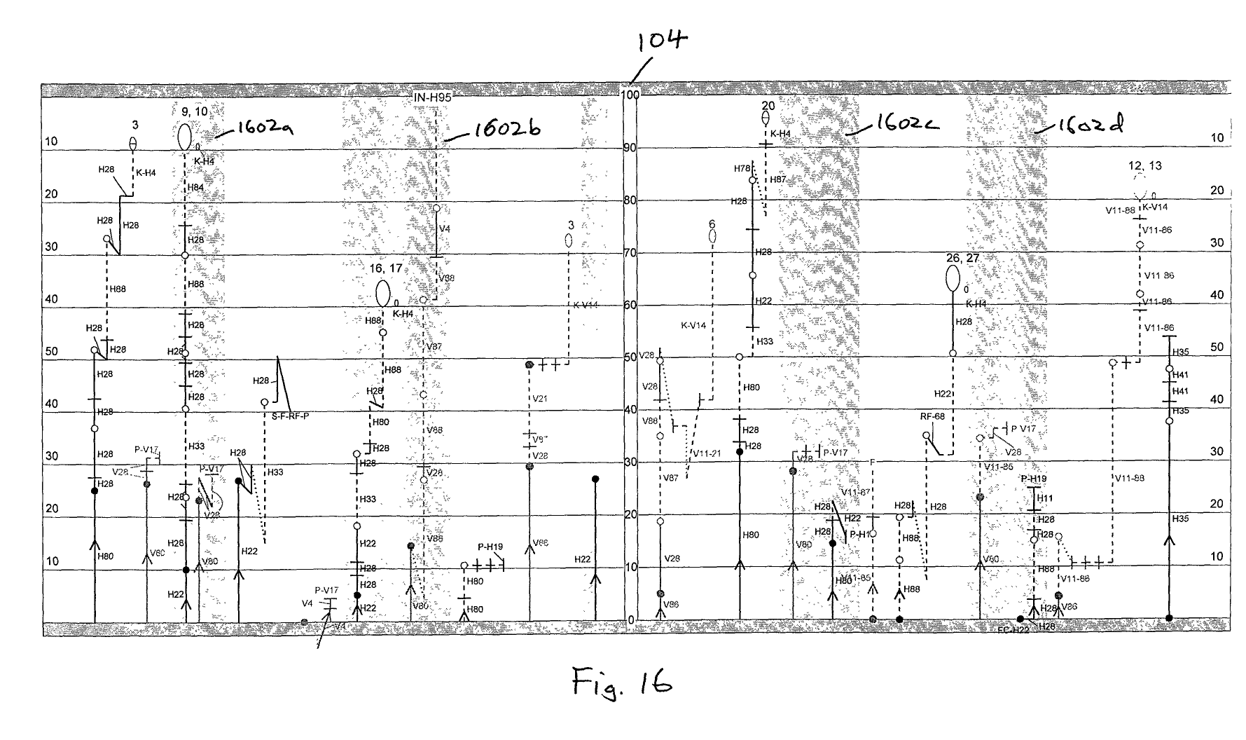

In the example embodiment shown, the information on the field portion 104 of the display medium 102 is read from left to right with respect to the temporal duration, or progress, of the game. The drive line at the far left of the grid 202 represents the drive that began when player number “80” of the home team caught the opening kick-off of the game. The drive line to the immediate right of this initial drive line (which advances in the opposite direction on the grid) represents the initial drive of the opposing team. The directional arrow (e.g., arrow 206a) at the beginning of each drive line indicates the direction in which the offense attempted to move the ball during the drive represented by that drive line. The drive lines in the FIG. 2 embodiment alternate (between teams) from left to right on the grid 202 in the order in which they occurred during the course of the game. The invention is not limited in this respect, however, and the drive lines may be oriented otherwise on the field in accordance with different embodiments of the invention, such as those described below in connection with FIGS. 16-18. In one embodiment, terse, boxed comments of so-called “color commentary,” e.g., color commentary boxes 208a-b, are included at select points on the grid 202 to comment on plays or developments that occurred during the game. These color commentary boxes, if used, can help the viewer gain a better understanding of the progression of the game.

As mentioned above, the instructions portion 108 of the display medium 102 may include instructions regarding how to properly interpret the information included on the field portion 104, the legend portion 106, and the roster portion 110, in combination. An example of the text that may be included in the instructions portion 108 follows:

A run is indicated by a solid line segment, a pass or kick by a dashed line segment, and a penalty by a dotted line segment. The number at the midpoint or end of each line segment representing a play is that of the player who ran with, caught, kicked, or punted the football during the play.

The beginning and end points of most plays are indicated by short hatch marks perpendicular to, or at an angle with, the line segments representing the plays. However, if special condition(s) existed before and/or after a play, e.g, an initial spot, a first down, or a score, appropriate symbol(s) are instead used to terminate the line segment representing the play. Additional symbols are also placed at or near the endpoints of some line segments to indicate other conditions and/or results of the plays represented thereby, e.g., to indicate that a sack, fumble, interception, etc., occurred during a particular play.

All plays are represented as if they had been executed in a straight line. All of the plays executed during a given possession are consolidated end-to-end to form a “drive line.” A seperate drive line is used to represent each possession. To facilitate the comparison of the drive lines of the two teams, the drive lines are drawn as if the teams did not switch sides at the end of each quarter. Each team's drive lines therefore progress in the same direction on the field throughout the game.

Diagonal line segments are used only to prevent overlapping with other line segments. Plays during which yardage was neither gained nor lost are represented using line segments perpendicular to the drive line.

All passes are thrown by starting quarterbacks unless otherwise indicated next to the line segment representing the pass. When a player other than the starting quarterback throws a pass, the thrower's number is indicated at or near the midpoint of the line segment representing the pass, followed by the receiver's number. Declined penalties and receivers who dropped passes are not indicated in most cases. Yardage of all plays is approximate. The flight of the ball on kickoffs, punts, and missed field goals is not shown. Kickoff and punt returns are depicted by solid lines.

It should be appreciated that the text above is only an example of text that may be included in the instructions portion 108 in connection with the FIG. 2 embodiment, and that different text may be appropriate in connection with alternative embodiments.

In addition to a viewer of the display medium 102 readily gathering information regarding the football game represented thereon, the embodiment of the display medium 102 of FIGS. 1-3 may be useful in many other applications. For example, because of the readily distinguishable nature of the symbols and the manner in which the symbols are represented on the grid 202, an electronic scanner may scan the display medium 202 to gather statistical information about the football game. The electronic scanner may, for example, identify the number of running plays that one of the two teams performed and/or a total number of yards gained during these running plays. In the FIG. 2 example, the number of running plays by the Home team may, for example, be calculated by using the scanner to count the number of dark, solid line segments on the grid 202. The total number of yards gained during the running plays of the Home team (in the FIG. 2 example) may be calculated, for example, by scanning each dark, solid line segment to measure its length, and adding together the lengths of all of the dark, solid line segments. Because the lengths of the line segments in the FIG. 2 example correspond to distances traversed on the football field during the plays represented thereby, the sum of the lengths of the dark, solid line segments may be used to calculate the total yardage gained by the running plays of the Home team. The player numbers next to the line segments in the FIG. 2 example may also be scanned, if desired, and used to calculate statistics for one or more particular players of the game. For example, the total yards gained by a particular player, or the total yards gained by a particular player during plays of a particular type, may be calculated using the scanning and line-segment measurement technique described above.

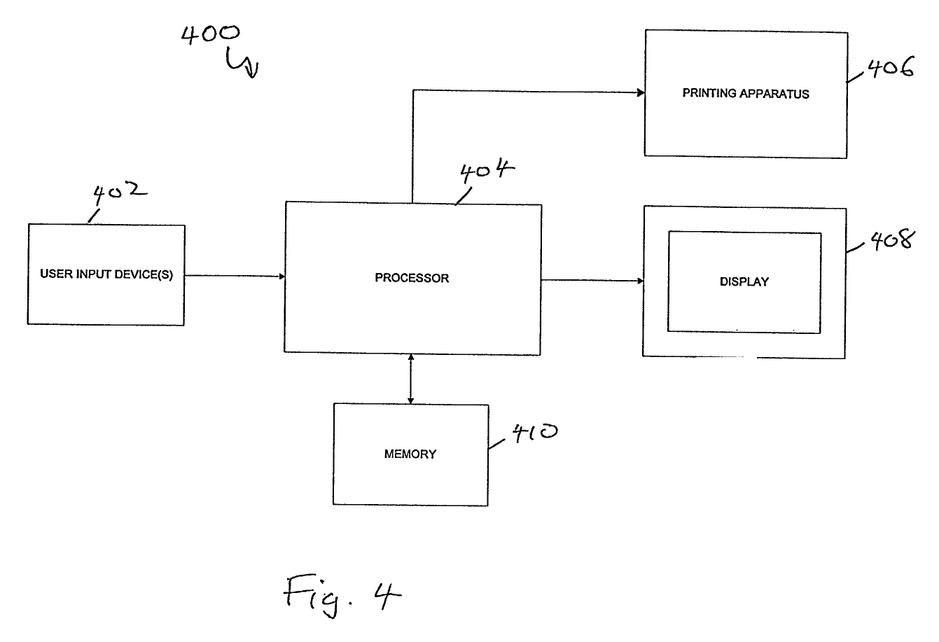

FIG. 4 is an example of a computer system 400 that may be used in connection with one embodiment of the present invention. As shown, the computer system 400 includes a processor 404, user-interface input/output (I/O) device(s) 402, a memory 410, a printing apparatus 406, and a display 408.

In one embodiment, a computer program may be stored in the memory 410, which, when executed by the processor 404, uses the display 408 to prompt the user to input information via the I/O device(s) 402 regarding each play of a football game. In one embodiment, the user is presented with a grid representing a football field and is permitted to identify locations on the grid (e.g., using a mouse) at which each play ended. In response to so identifying each location on the grid, a user-input screen is presented to the user so that the user may input relevant information about the play. In one embodiment, a segment of a drive line is added to the grid immediately after the user finishes inputting information via this input screen. The information input by the user may be stored in the memory 410 where it may be accessed by the processor 404.

Instructions may also be stored in the memory 410 which, when executed by the processor 404, cause previously stored information regarding a football game to be retrieved from the memory 410 so that a representation of one or more plays of the football game may be printed on a substrate by the printing apparatus 406 or displayed by the display 408. This stored information may be retrieved from the memory 410 at any time after it is stored. In one embodiment, a shared database may be used to store the information, and separate computers may be used for storing the data in and retrieving the data from the database. The memory 410 may, for example, constitute a server that is accessible via the Internet, and information regarding one or more football games may be stored by the server, and may be accessed from or downloaded to a personal computer at remote location via an Internet connection.

The instructions stored by the memory 410 may be implemented using any of numerous programming languages, and the invention is not limited to any particular programming language. In one embodiment, for example, Microsoft Visual C++ using Microsoft Foundation Classes is employed to implement the invention.

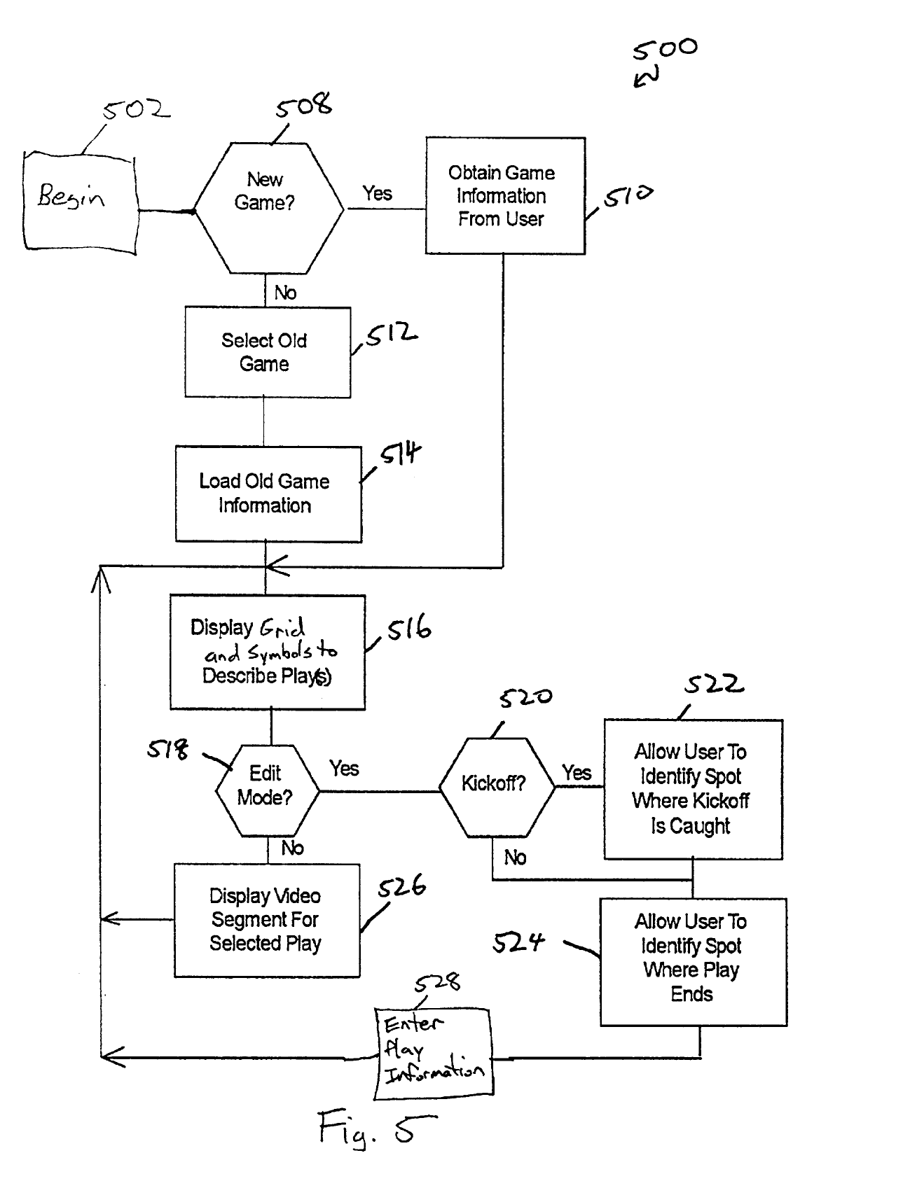

FIG. 5 is an example of a flow diagram illustrating a computer-implemented routine 500 that may be executed by the processor 404 (FIG. 4) to prompt the user to input information regarding the various plays of a football game, and to represent such plays symbolically on a grid representing a football field, or to display a representation of a football game based on previously stored information. The user may input information regarding a football game while the game is being played, or at a later time. A user may, for example, input information after the completion of a football game based on handwritten notes of the game's plays, or using a videotape replay of the game.

As shown in FIG. 5, the routine 500 begins at a step 502 and proceeds immediately to a step 508, at which the user is given the option to begin inputting information regarding a new football game, or to select an old game for which information was previously stored in the memory 410.

If, at the step 508, the user opts to select an old game, the routine 500 proceeds first to a step 512, at which the user is prompted to select a previously stored game, and then proceeds to a step 514, at which information regarding the selected game is retrieved from the memory 410. After the step 514, the routine 500 proceeds to a step 516, wherein a grid representing a football field and symbols illustrating the plays in the selected football game are rendered on the display 408, or are provided to the printing apparatus 406 to print them on a substrate.

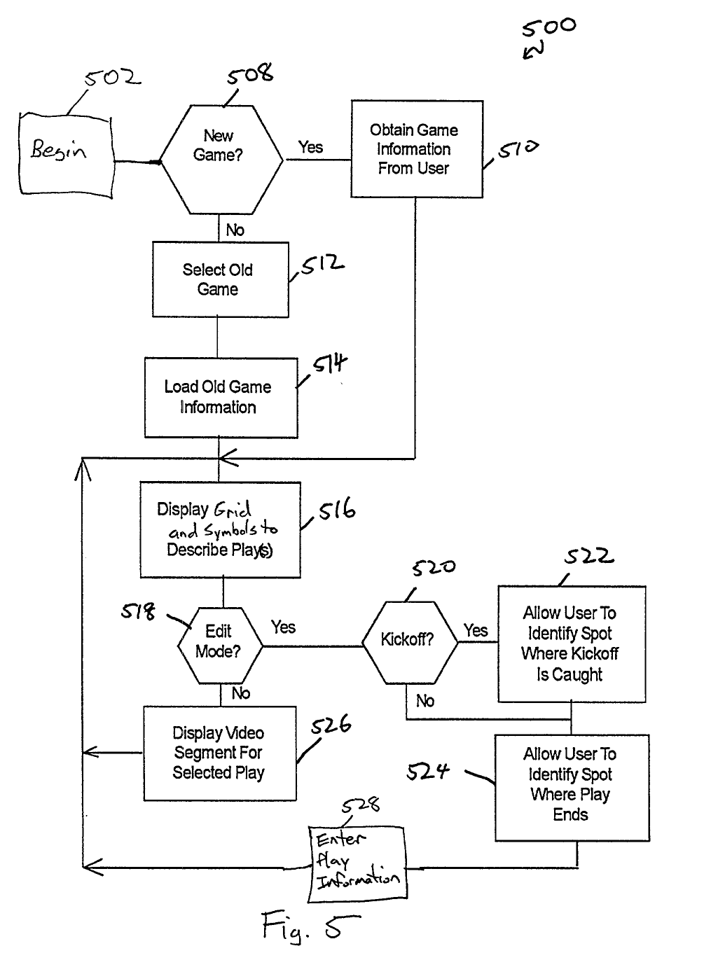

If, at the step 508, the user opts to begin storing information regarding a new football game, the routine 500 proceeds to a step 510, at which the user is prompted to input information regarding particulars of the new football game. The user may input this information in any of numerous ways, and the invention is not limited to any particular input method. One example of a user-input screen that may be displayed to the user to permit the user to input the relevant information regarding a football game is shown in FIG. 6.

As shown in FIG. 6, the user may be prompted to input information regarding the names of the visiting team (window 602a) and the home team (window 602b), the name of the stadium at which the football game was or is being played (window 604a), the city in which the stadium identified in the window 604a is located (window 604b), and the date that the football game was or is being played (window 604c).

In one embodiment, the names of the teams can be selected from pull-down menus which appear in response to buttons 606a and 606b being pressed (e.g., using a mouse). Based on the names of the teams selected in this manner and the current date indicated by the computer's clock/calender, the information in the windows 604a-c may be automatically updated. In the example shown, the pull-down menus provided in response to the buttons 602a-b being pressed include names of all of the teams in the same league (i.e., the NFL).

As shown in the FIG. 6 example, the user may also be prompted to identify which team kicked or will kick-off to open the football game (bubbles 610a-b), to identify whether the playing surface is grass or artificial turf (bubbles 612a-b), and to input information regarding any weather conditions of note that existed or exist during the football game (window 614). After inputting the required information, the user may click on an “OK” button 608 in the window 600 to indicate that all of the required information has been entered.

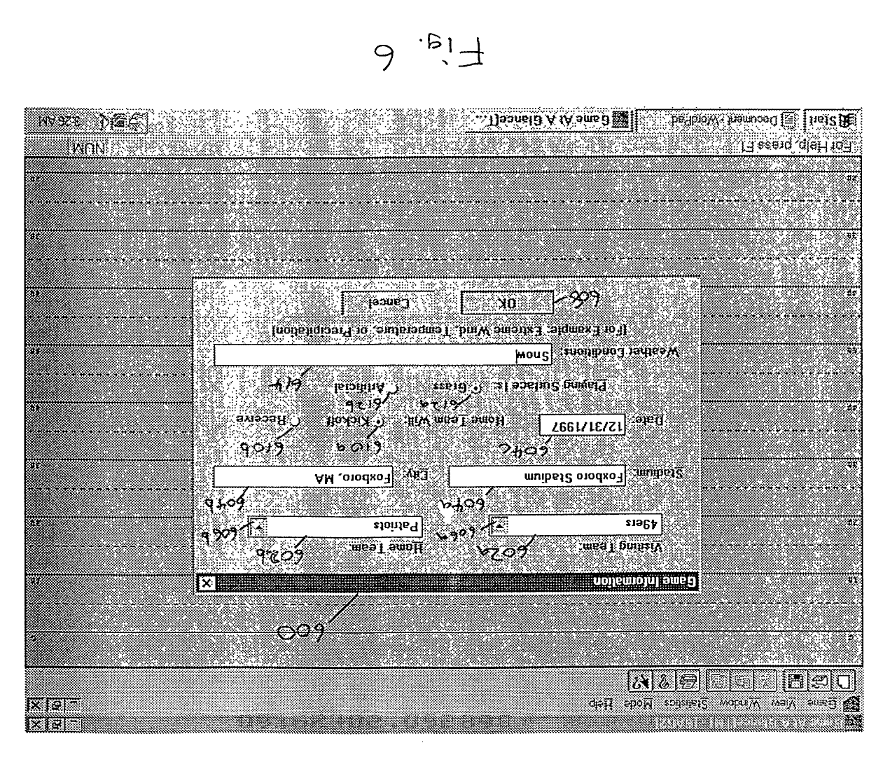

Referring again to FIG. 5, after the step 510 is complete, the routine 500 proceeds to the step 516, at which a grid representing a football game and symbols are displayed on the display 408 to represent any plays of the football game for which information has been input. Because no information regarding the plays of the football game has been input by the user when the step 516 is first reached after completing the step 510, no symbols are rendered on the field at the step 516, and the grid representing the football field may appear, for example, as shown in FIG. 7.

In the FIG. 7 example, the horizontal lines (e.g., line 704) drawn width-wise across the grid 202 correspond to the yard lines of the football field on which the football game was or is being played. In the FIG. 7 embodiment, the ratio of the width of the grid 202 (i.e., between the side lines) to its length (i.e., between the end zones) is significantly greater than the width-to-length ratio of a standard football field (i.e., 160-to-300). In different embodiments, the grid 200 may be as wide, or even twice as wide, as it is long. This characteristic of the grid 202 permits a large number of drives, displayed as predominantly vertical lines oriented parallel to the sidelines, to be represented side-by-side across the grid 202 (as shown in FIG. 2). It should be appreciated, however, that the invention is not limited to a grid 202 of any particular size. In the example shown in FIG. 7, an icon 702 (which may be shaped, for example, like a football) is provided on the grid 202, and may be manipulated by a user (e.g., using a mouse) to any location on the grid 202.

Referring again to FIG. 5, after the step 516 is complete, the routine 500 proceeds to a step 518, at which it is checked whether “edit mode” or “view mode” is currently selected. The user may adjust the mode of operation of the routine 500 in any of numerous ways, and the invention is not limited to any particular technique for changing modes. In the embodiment of FIGS. 7-15, for example, the user may manipulate a mouse to click on a pull-down menu titled “Mode,” and select either the edit mode or the view mode from the options provided by the menu.

If, at the step 518, it is determined that the program is currently in the view mode, then the routine 500 proceeds to a step 526, at which a video segment for a play may be identified by the user and displayed on the display 408. This feature is described in more detail below.

If, at the step 518, it is determined that the program is currently in the edit mode, then the routine 500 proceeds to a step 520, at which it is determined whether the play for which information is currently being input is a kick-off. If the play is a kick-off, then the routine 500 proceeds to a step 522, at which the user is permitted to identify a location on the grid 202 where the kick-off was caught by one of the players. The user may, for example, manipulate a mouse to move the icon 702 (FIG. 7) so that it points to an appropriate location on the grid 202, and click on the mouse when the icon 702 is at the selected location. After the step 522, the routine 500 proceeds to a step 524 (described below).

If, at the step 520, it is determined that the play for which information is currently being input is not a kick-off, then the routine 500 proceeds immediately to the step 524. At the step 524, the user is permitted to identify a location on the grid 202 (e.g., using a mouse) corresponding to a position on the football field at which the play ended (e.g., where a player was tackled, etc.). In response to the user identifying a location on the grid 202 at the step 524, the routine 500 proceeds to the step 528, at which a user-input screen (described below) is presented to the user so that the user can input information regarding the play.

After the user has finished inputting information at the step 528, the routine 500 proceeds back to the step 516, at which the grid 202 and symbols representing plays of the football game for which information has been input are rendered on the display 408.

FIGS. 7-15 illustrate how the display 408 may appear as information is being input by a user when the routine 500 (FIG. 5) is being executed. In the example of FIGS. 7-15, the opening kickoff of the football game was caught by player number “28” on the twenty-five yard line of the football field, and the player was tackled at the “15” yard line. As shown in FIG. 7, to indicate the field position at which the opening kickoff was caught, the user may move the icon 702 (e.g., using a mouse) to point to and click on the line of the grid 202 corresponding to the “25” yard line of the football field. This action by the user may correspond to the step 522 of the routine 500.

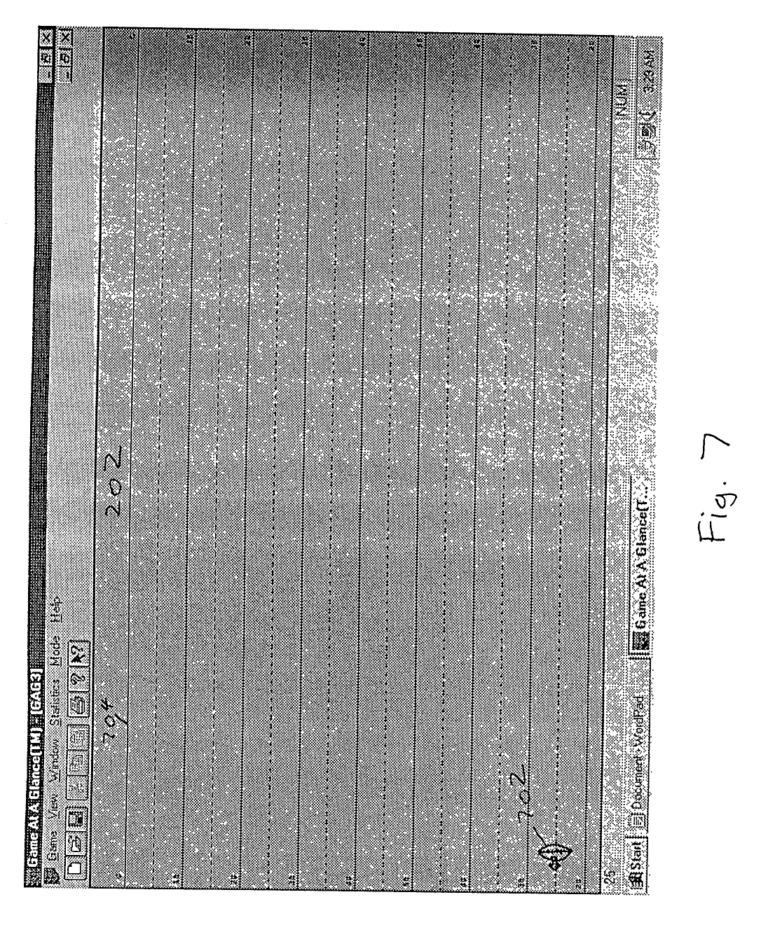

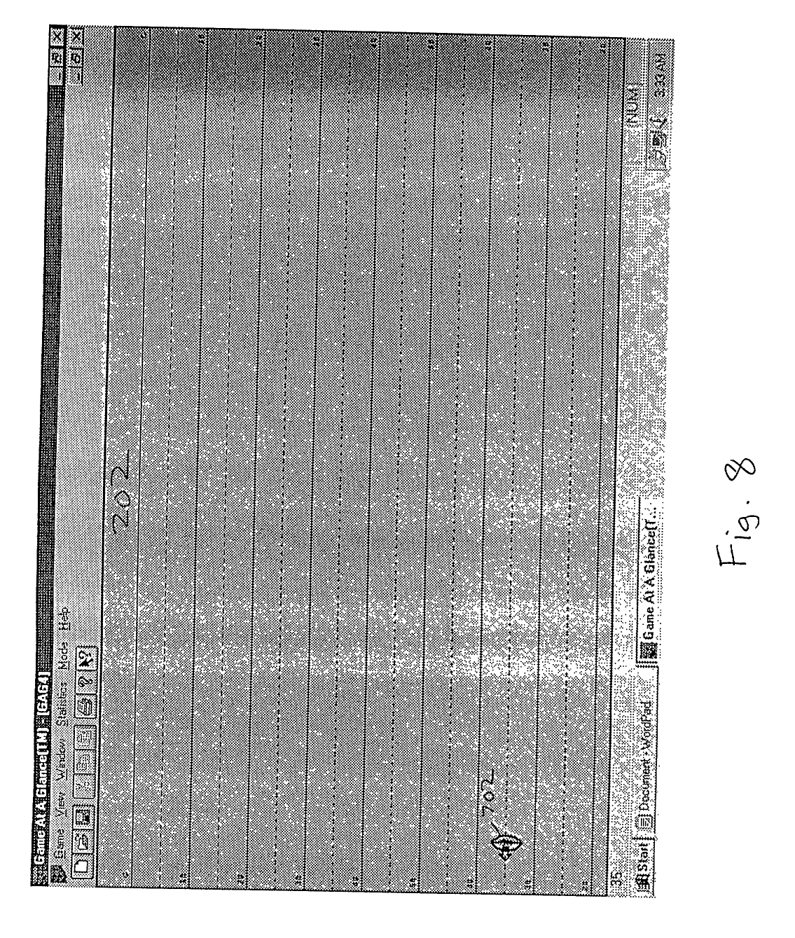

After indicating that the kickoff was caught on the “25” yard line, the user may again move the icon 702 to a location on the grid 202 corresponding to a location on the football field at which the forward motion of player that caught the opening kick-off was stopped (i.e., the “35” yard line), and may click the mouse at this location. This action by the user may correspond to the step 524 in the routine 500 and is illustrated in FIG. 8, wherein the icon 702 points to the line on the grid 202 corresponding to the “35” yard line of the football field. In response to the user clicking on the line corresponding to the “35” yard line, a user-input screen 900 (shown in FIG. 9) is presented to the user on the display 408 to permit the user to input information regarding the play that the user just indicated ended on the “35” yard line.

As shown in FIG. 9, the user-input screen 900 permits the user to identify (using bubbles 902a-d) the type of play that occurred (i.e., a run, pass, kick, or punt), and to identify (using window 904) the number of the player responsible for moving the ball on the football field (e.g., the runner or pass receiver) during the play. A window 906 is also provided to permit the user to adjust the yard line at which the play ended, in case the location on the grid 202 that was pointed to in the step 524 does not accurately correspond the yard line at which the play ended. The yard line in the window 906 may be updated automatically based on the location on the grid 202 at which the icon 702 was located when the user clicked on the mouse in the step 524. The user may input information into the windows 904 and 906, for example, by using the mouse to move a cursor (not shown) into the window, and clicking an appropriate mouse button, thereby leaving a cursor in the window. After a cursor is in one of the windows 904 and 906, the user may input information, for example, using a keyboard.

As shown in FIG. 9, the user-input screen 900 may also permit the user to indicate whether a penalty was called (box 912), whether a score occurred (box 914), whether a score was nullified by a penalty (box 916), whether one or more significant actions occurred during the play (box 918), whether the play ended in a first down (box 920), and the team that was or is in possession at the end of the play (926).

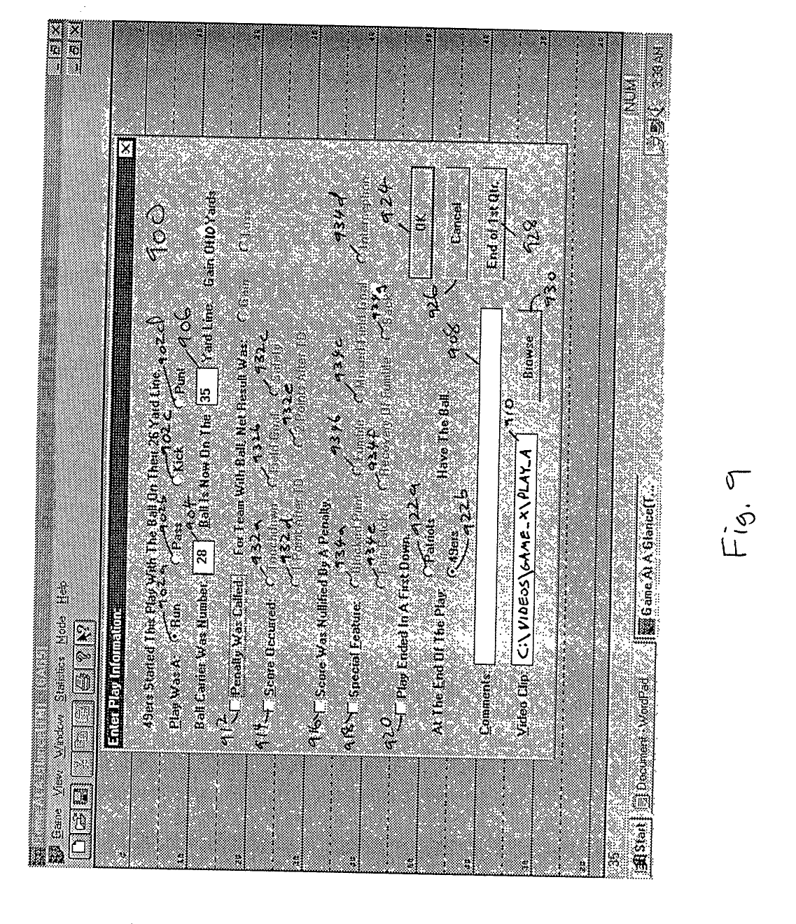

If a penalty was called during the play, the user may use the mouse to check the box 912 to indicate that this was the case. In the FIG. 9 example, when the box 912 is checked, the user is permitted to indicate whether the penalty resulted in a net gain or loss of yardage during the play. Alternatively, a more detailed option screen (e.g., screen 1000 in FIG. 10) may be presented to the user as a result of the box 912 being checked, thereby permitting the user to input more detailed information about the penalty.

When the box 914 is checked to indicate that a score occurred during the play, the user is permitted to indicate whether the score was a touchdown (bubble 932a), a fieldgoal (bubble 932b), a safety (bubble 932c), or extra points (one—bubble 932d, or two—bubble 932e). The checking of the box 916 permits a user to indicate that a score that occurred (as indicated by the checking of the box 914) was nullified by a penalty.

When the box 918 is checked, the user is permitted to identify one or more particular actions that occurred during the play. In the FIG. 9 example, these actions include: a blocked punt (bubble 934a), a fumble (bubble 934b), a missed field goal (bubble 934c), an interception (bubble 934d), a fair catch (bubble 934e), recovery of a fumble (bubble 934f), and a sack (bubble 934g). The checking of the box 920 indicates that the play ended in a first down. If a change of possession occurred during the play, the user may use the mouse to click on one of bubbles 922a-b to indicate that such was the case.

Using the embodiment of the user-input screen 900 shown in FIG. 9, the user is also permitted to enter any comments in a window 908 that the user wishes to appear on the grid 202 next to the line segment representing the play. This feature therefore permits the user to add “color commentary” regarding various plays in the game.

In addition, in the FIG. 9 embodiment, the user is permitted to input information into a window 910 that identifies a “video-clip” file that the user wishes to be associated with the play. A browse button 930 is provided to permit the user to browse through various video clips currently stored in the memory 410. If a video clip is identified for a particular play, then, when the view mode is selected by the user (as described above), when the user clicks the mouse on the line segment representing the play, a program (e.g., an Apple Quick Time Viewer™) is called that plays the identified video clip. This feature is described in more detail below.

After all the relevant information for the play has been input by the user, the user may click an “OK” button 924 or an “End of First Quarter” button 928 to indicate that the user is through inputting information for the play. Clicking a “Cancel” button 926 causes the screen 900 to disappear, and permits the user to relocate the icon 702 (at the step 524 of the routine 500).

In the example described above in which a player number “28” caught the opening kickoff at the “25” yard line and ran the ball back to the “35” yard line, information may be input to the user-input screen 900 as shown in FIG. 9. That is, the bubble 902a may be marked to indicate that a running play occurred, “28” may be entered in the window 904 to indicate the number of the ball carrier, “35” may be entered in the window 906 to indicate that the play ended on the “35” yard line, and a location of a video clip for the play may be entered in the window 910.

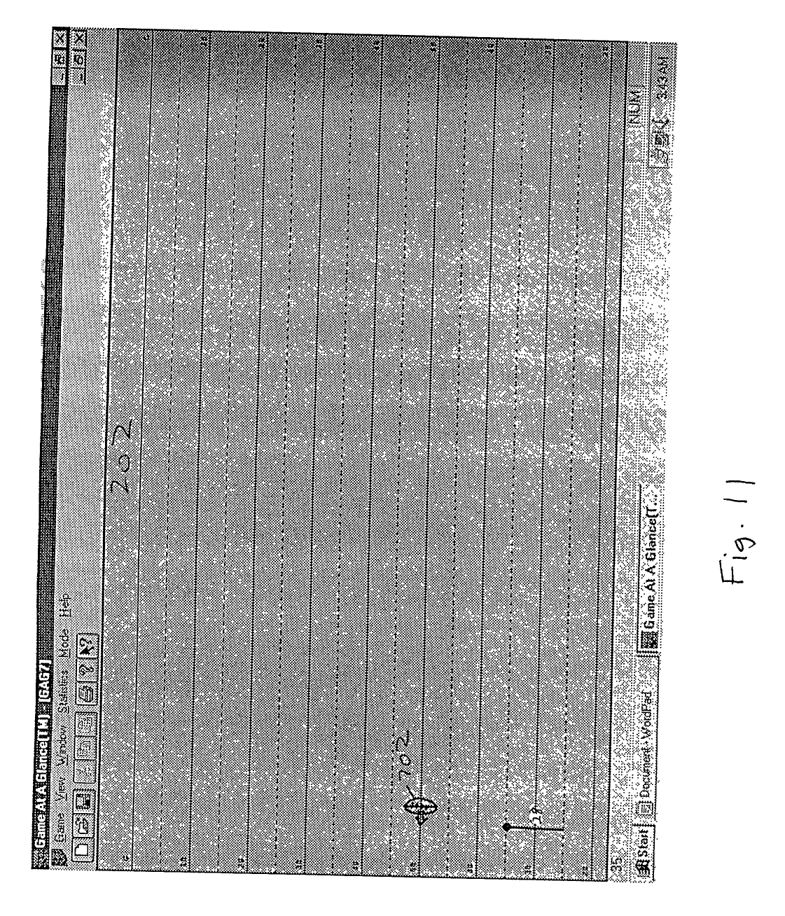

In response to the user clicking the “OK” button 924 in the FIG. 9 example, a solid line (indicating a running play) is drawn from the “25” yard line to the “35” yard line on the grid 202, and a solid dot (indicating an initial spot) is added to the end point of the line. This adding of a line and a dot to the grid 202 may correspond to the step 516 in the routine 500 (FIG. 5). An example of how such a solid line and dot may appear in accordance with the above-described example is shown in FIG. 11.

After the line and dot are added to the grid 202 as shown in FIG. 11, the routine 500 proceeds again to the step 524 (via steps 518 and 520). At the step 524, the user again is permitted to move the icon 702 to a new location on the grid 202 to indicate a location on the field where a subsequent play of the football game ended. In FIG. 11, for example, the grid 202 is shown as it may appear when the user is identifying that the next play ended at the “50” yard line of the football field.

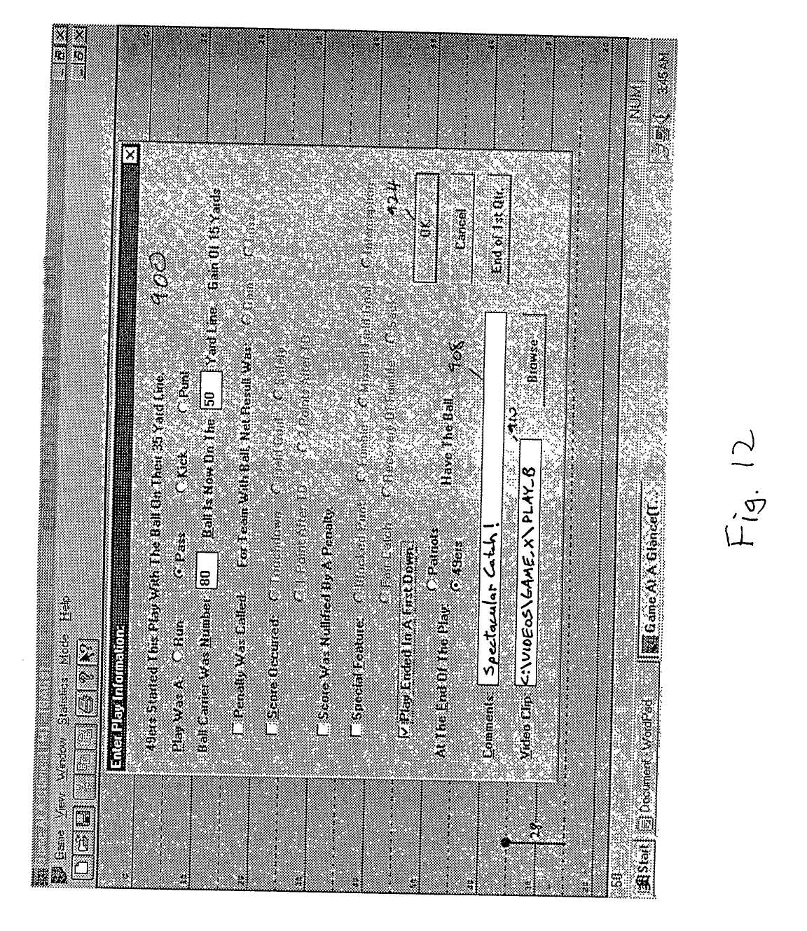

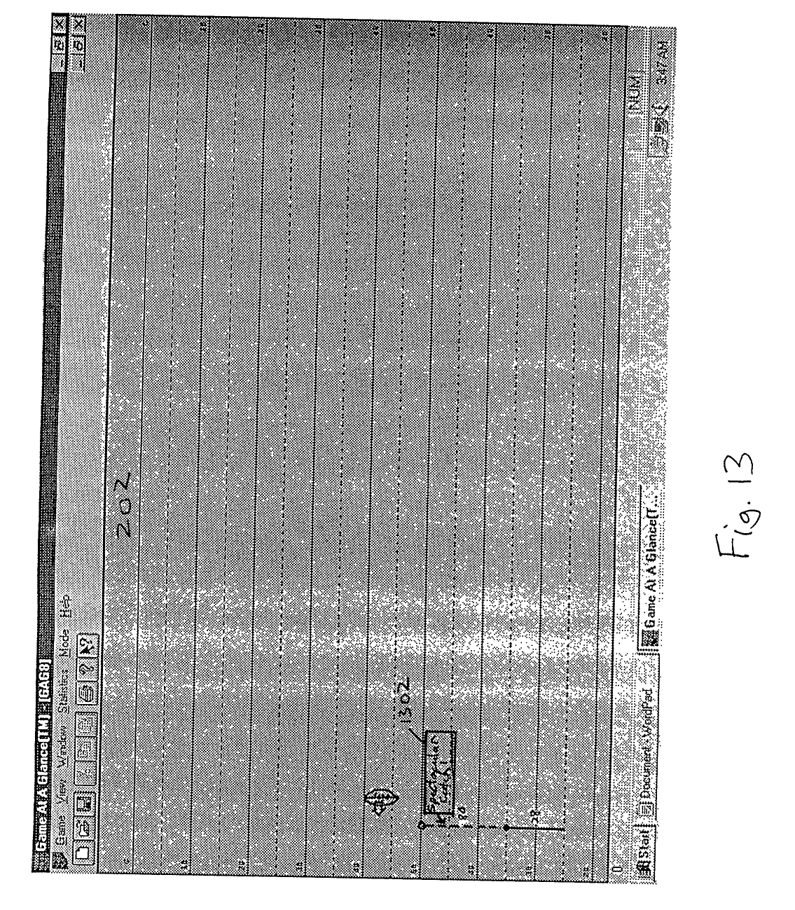

In response to the user pressing the mouse button when the icon 702 is pointing to the line on the grid 202 corresponding to the “50” yard line of the football field, the routine 500 proceeds to the step 528, at which a fresh screen 900 (as shown in FIG. 12) is presented to the user on the display 408 to permit the user to input information regarding the play. As indicated in the FIG. 12 example, this play was a pass to player number “80” for a gain of “15” yards, and the play ended in a first down. As shown in FIG. 12, a comment is also entered in the window 908, and a location of another video-clip file is entered in the window 910. When the user clicks on the “OK” button 924, the routine 500 again proceeds to the step 516, at which a dashed line segment (indicating a pass) is drawn on the grid 202 between the “35” yard line and the “50” yard line (as shown in FIG. 13). Because the play ended in a first down, the dashed line terminates with an unfilled circle (see the legend 106 in FIG. 3). In the embodiment shown, a color commentary box 1302 containing the textual commentary input into the window 908 is also displayed on the grid 202 next to the dashed line representing the play.

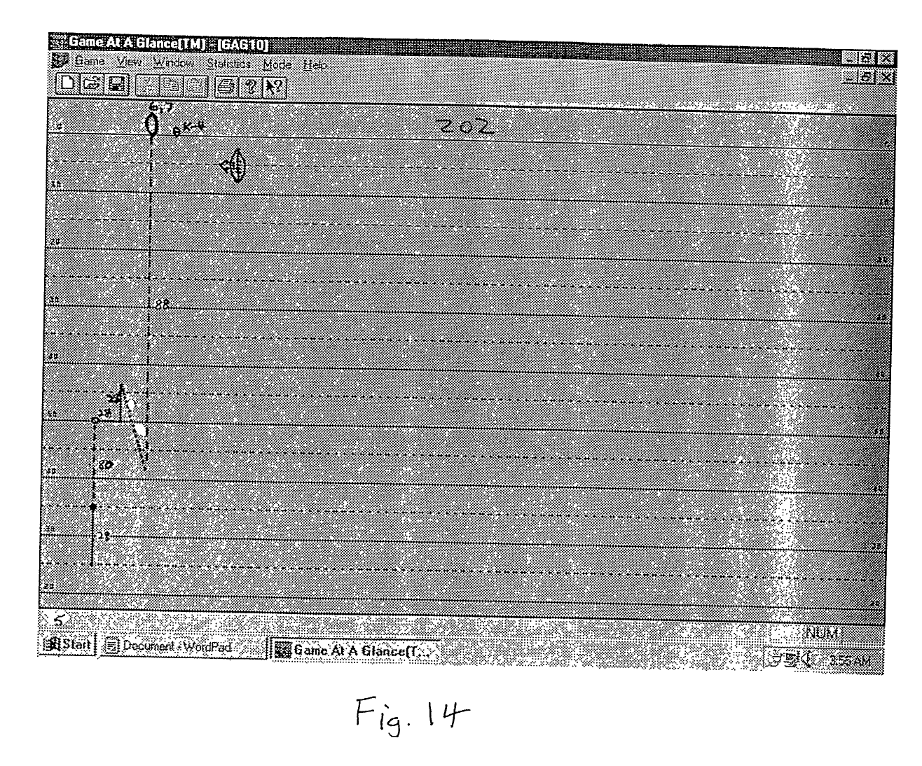

The user can continue to input information regarding the plays in each drive of a football game in the above-describe manner so that line segments (either dotted, dashed, or solid) are caused to be drawn on a grid 202 to represent the plays. FIG. 14 shows an example of a single drive line which was drawn in accordance with the routine 500. The several drive lines of a football game may be drawn in this manner so that each play of each drive of the football game may be represented on the grid 202 (e.g., as shown in FIG. 2).

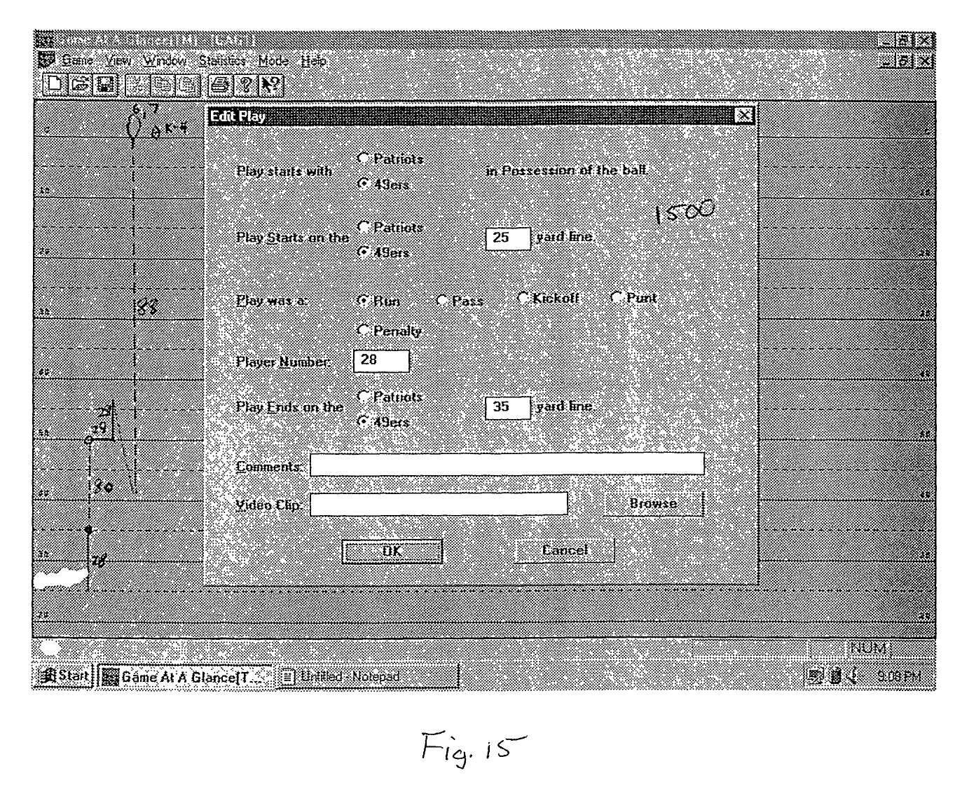

If the routine 500 is in edit mode (which, as describe above, may be selected using a pull down menu titled Mode in connection with the embodiment of FIGS. 7-15), when the user clicks on one of the line segments on the grid 202, a user-input screen 1500 (shown in FIG. 15) may be caused to appear on the display 408 to permit the user to alter the information pertaining to the play represented by the clicked-on line segment. FIG. 15 shows the user-input screen 1500 as it may appear after the user has clicked on the solid line segment (in FIG. 14) between the twenty-five and thirty-five yard lines.

In addition to the pull-down menu titled Mode, the embodiment of FIGS. 7-15 may include a number of additional pull-down menus to permit the user to invoke additional features. For example, a pull-down menu titled “Game” may permit the user to open a new game, to open an old game, to save the currently open game to memory, to save the currently open game using a new file name, or to print the grid 202 in its current state. A pull-down menu titled “Statistics” may permit the user to view or print statistics regarding the currently open game. These statistics may be calculated based on the information that has been input and stored regarding the plays of the game. It should be appreciated that the pull down menus used in connection with in the embodiment of FIGS. 7-15 constitute only one example of how a user may be permitted to select from among various options, and the invention is not limited to the use of the particular pull down menus shown, or to the use of pull down menus in general.

In another embodiment, a diagram such as that shown in FIG. 2 may be generated using a computer aided design (CAD) program having a specialized page layout and one or more specialized templates. The specialized page layout may provide a grid including horizontal lines corresponding to the yard lines of a football field similar to the horizontal lines shown in FIG. 2. The specialized template(s) may include symbols corresponding to each of the possible plays that may occur during a football game, as well as the possible results of such plays. For example, a template may be provided that appears similar to the legend 106 shown in FIG. 3.

In such an embodiment, a user may, for example, select symbols from the specialized template(s) (e.g., using a mouse), and drag and drop these symbols onto the grid representing the football field. After being dragged and dropped onto the grid, the user may, for example, manipulate the size and characteristic(s) of each of the symbols so as to make it correspond to the lengthwise (i.e., end zone to end zone) position on the football field at which the play occurred. In this manner, the user may add as many symbols to the page layout as necessary to represent every play and every drive of a football game.

Each of FIGS. 16-18 is a diagram of the field portion 104 of the display medium 102 as it may appear in accordance with an alternative embodiment of the invention. Each of the diagrams shown in FIGS. 16-18 may be constructed, for example, by the processor 404 (FIG. 4) examining the data stored in connection with the FIG. 2 embodiment, and re-positioning and/or re-orienting the drive lines in accordance the criteria specified for each alternative embodiment, as described below.

In the example alternative embodiment shown in FIG. 16, the field portion 104 portrays the drives of each team (on a scale of zero to one-hundred yards) over the course of an entire football game. In this embodiment, the order of the drives from left to right follow the temporal progress of the game, and therefore appear side-by-side in alteration, but the drive lines all begin at the zero yard line and all proceed in the same direction, rather than in opposite directions, on the field. In the embodiment shown, shading is used (see shaded areas 1602a-d) to permit adjacent pairs of drives (each pair including one drive by each team) to be distinguished from one another. This representation makes possible a side-by-side comparison of the response each team makes (in terms of the length of the drive it achieves) to the immediately preceding drive of its opponent. It should be appreciated that the shading technique used in connection with the FIG. 16 embodiment is only one example of a technique that may be used to distinguish adjacent pairs of drives, and that any of numerous alternative techniques may alternatively be employed. The invention is not limited to any particular technique for distinguishing between pairs of drives.

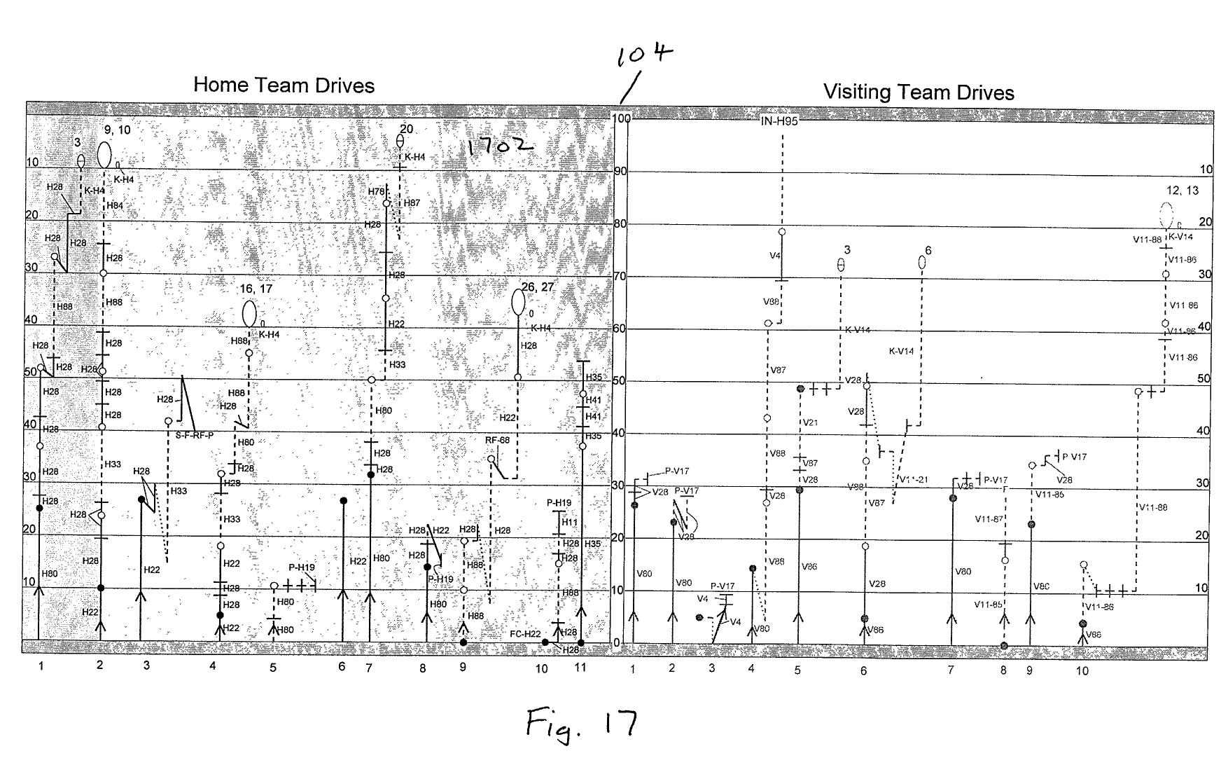

The example alternative embodiment shown in FIG. 17 also portrays the drives of both teams (beginning at the zero yard line and going in the same direction on a scale of zero to one-hundred yards) over the course of an entire game. The FIG. 17 embodiment differs from the FIG. 16 embodiment, however, in that the drives of the opposing teams are segregated by team, rather than appearing side-by-side in alternation as in the FIG. 16 embodiment. All of the drives of the home team appear on the left half of the diagram (see shaded area 1702), and those of the visiting team appear on the right half. The drives of each team are represented (from left to right) in the order in which they occurred during the game.

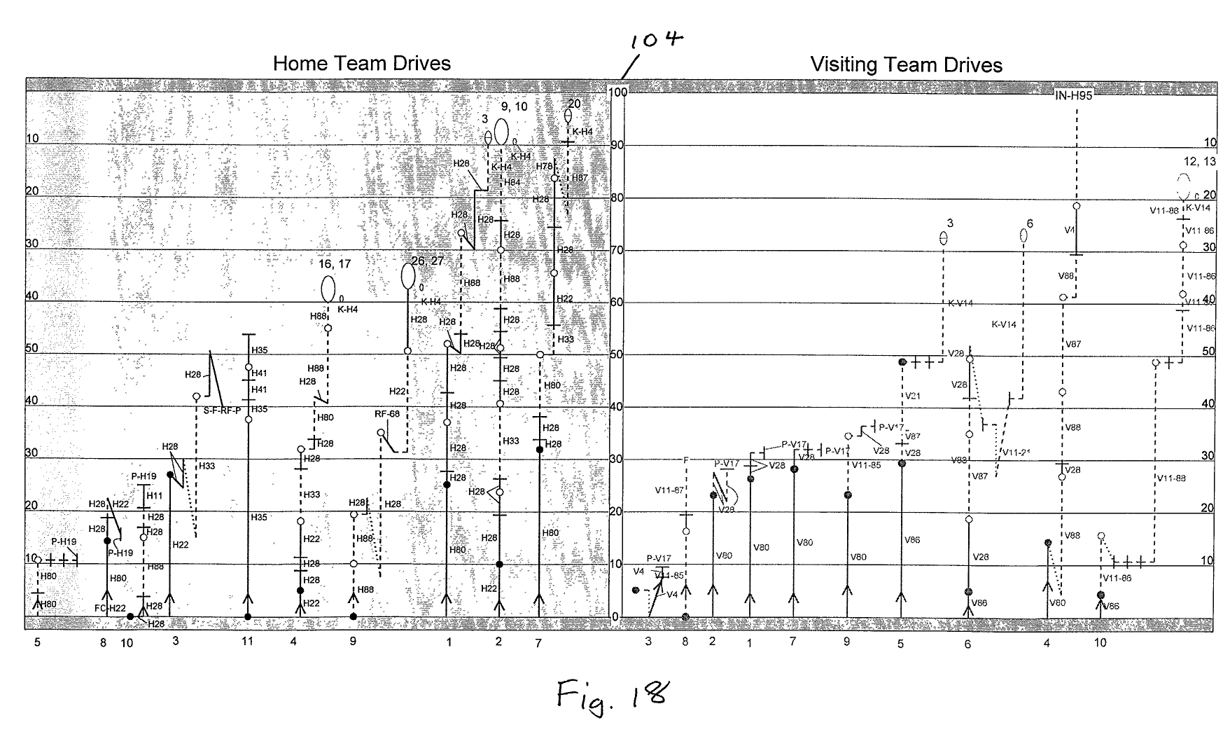

The example alternative embodiment shown in FIG. 18 is similar to that shown in FIG. 17, except that the drives of each team, segregated by team, are not portrayed in the order in which they occurred during the game. Rather, the drives of each team are portrayed (from left to right) in the order of the length of the drives. That is, the drives of the home and visiting teams are portrayed (on the left and right halves, respectively, of the diagram) beginning with each team's shortest drive (on the left) and ending with its longest drive (on the right).

It should be appreciated that, in addition to the example embodiments of FIGS. 2 and 16-18, drive lines for a football game similar to those described above may be oriented in any other fashion so as to convey useful information to the person viewing them, and the invention is not limited to the particular arrangements and orientations of drive lines shown.

As mentioned above, in embodiments of the invention in which diagrams such as those shown in FIGS. 2 and 16-18 are portrayed on a computer display, a user may identify (e.g., using a mouse or touch screen) a particular line segment or symbol on a diagram to cause the computer system 400 (FIG. 4) to produce a live-action video replay of the identified play. The selection of a particular line segment may, for example, cause the processor 404 to access data stored in the memory which, when processed by a video driver, causes the video image to be generated from the data and produced on the display 408. Alternatively, the selection of a line segment may cause the processor 404 to cause an external video replay device (not shown) to generate a video image on the display 408 or another display.

In one embodiment, an on-screen graphic for television (TV) use is produced such that, after each touchdown, an animation-style image of a football field appears, and an eye-level point of view is established at the end line of the end zone in which the touchdown was scored, so that the view on the TV screen is down the length of the football field. A large symbol of a football may be made visible on the ground in the end zone in which the score just occurred. The point of view may then rise to a height of approximate fifty to one-hundred feet so as to create an elevated shot of the entire length of the football field. The drive line that led to the score may then be superimposed on this animation-style image of the field. This drive line may include, for example, the details described above in connection with the embodiment of FIG. 2. It should be appreciated that any of numerous graphics similar to that described above may be employed in connection with the invention, and that the invention is not limited to the particular graphic described.

After the animation-style graphic of the entire field (with the drive line superimposed thereon) is provided on the TV screen, a user (e.g., a commentator) may move the cursor from one line segment to another. When the user clicks on a particular line segment, a live-action video replay of the identified play may be provided on the television screen. At the completion of a particular live-action video replay, the animation-style image of the entire field may be caused to reappear.

In one embodiment, all line segments representing plays during which a particular player cause the ball to move on the field may be highlighted on the display medium 102 so as to show the frequency and effectiveness with which the player performed during a portion as to show the frequency and effectiveness with which the player performed during a portion 24 or all of the football game. In embodiments in which a computer screen displays a football game, the plays for a particular player may, for example, be caused to blink.

Having described at least one embodiment in detail, various modifications and improvements will readily occur to those skilled in the art. Such modifications and improvements are intended to be within the spirit and scope of the invention. Accordingly, the foregoing description is by way of example only, and is not intended to be limiting.

What is claimed is:

1. An article of manufacture for conveying information regarding a football game between two teams, comprising:
a substrate; and
a plurality of symbols rendered on the substrate along a path representing at least a portion of a drive by one of the two teams, the plurality of symbols representing at least two plays that occurred during the drive such that each of the at least two plays can be distinguished from the other of the at least two plays.

2. The article of manufacture as claimed in claim 1, further comprising a plurality of parallel lines, rendered on the substrate, representing marked yard lines of a football field on which the football game was or is being played, and wherein positions of the plurality of symbols with respect to the plurality of parallel lines correspond to yard lines of the football field at which each of the at least two began and ended.

3. The article of manufacture as claimed in claim 2, wherein the plurality of symbols includes a plurality of line segments, each of the plurality of line segments representing a corresponding one of the at least two plays and extending between positions on the substrate, with respect to the plurality of parallel lines, corresponding to yard lines on the football field at which the one of the at least two plays began and ended.

4. The article of manufacture as claimed in claim 1, wherein different types of symbols are used to represent different types of plays.

5. The article of manufacture as claimed in claim 1, wherein additional symbols are rendered on the substrate so that the plurality of symbols and the additional symbols together represent all plays that occurred during at least a quarter of the football game, the plurality of symbols and the additional symbols representing the plays that occurred during the quarter such that each of the plays can be distinguished from the others of the plays.

6. The article of manufacture as claimed in claim 1, wherein additional symbols are rendered on the substrate so that the plurality of symbols and the additional symbols together represent all plays that occurred during at least a half of the football game, the plurality of symbols and the additional symbols representing the plays that occurred during the half such that each of the plays can be distinguished from the others of the plays.

7. The article of manufacture as claimed in claim 1, wherein additional symbols are rendered on the substrate so that the plurality of symbols and the additional symbols together represent all plays that occurred during the entire football game, the plurality of symbols and the additional symbols representing the plays that occurred during the football game such that each of the plays can be distinguished from the others of the plays.

8. The article of manufacture as claimed in claim 1, wherein the plurality of symbols identifies at least one player that was involved in each of the at least two plays.

9. The article of manufacture as claimed in claim 8, wherein the plurality of symbols identifies at least one player that was responsible for moving the football on the football field during each of the at least two plays.

10. The article of manufacture as claimed in claim 1, wherein the plurality of symbols includes a plurality of line segments, each of the plurality of line segments representing a corresponding one of the at least two plays.

11. The article of manufacture as claimed in claim 10, wherein the plurality of line segments are joined end-to-end to form a drive line representing the drive.

12. The article of manufacture as claimed in claim 10, wherein different types of line segments are used to represent different types of plays.

13. The article of manufacture as claimed in claim 1, further including additional symbols rendered on the substrate that indicate results, if any, of each of the at least two plays.

14. An apparatus for producing an article of manufacture that conveys information regarding a football game between two teams, comprising:
a printing device configured to render a plurality of symbols on a substrate along a path representing at least a portion of a drive by one of the two teams, the plurality of symbols representing at least two plays that occurred during the drive such that each of the at least two plays can be distinguished from the other of the at least two plays.

15. The apparatus as claimed in claim 14, wherein the printing device is configured to render a plurality of parallel lines on the substrate representing marked yard lines of a football field on which the football game was or is being played, and to render the plurality of symbols on the substrate such that positions of the plurality of symbols with respect to the plurality of parallel lines correspond to yard lines of the football field at which each of the at least two began and ended.

16. The apparatus as claimed in claim 15, wherein the printing device is configured to render the plurality of symbols as a plurality of line segments, each of the plurality of line segments representing a corresponding one of the at least two plays and extending between positions on the substrate, with respect to the plurality of parallel lines, corresponding to yard lines on the football field at which the one of the at least two plays began and ended.

17. The apparatus as claimed in claim 14, wherein the printing device is configured to render different types of symbols on the substrate to represent different types of plays.

18. The apparatus as claimed in claim 14, wherein the printing device is configured to render additional symbols on the substrate so that the plurality of symbols and the additional symbols together represent all plays that occurred during at least a quarter of the football game, the plurality of symbols and the additional symbols representing the plays that occurred during the quarter such that each of the plays can be distinguished from the others of the plays.

19. The apparatus as claimed in claim 14, wherein the printing device is configured to render additional symbols on the substrate so that the plurality of symbols and the additional symbols together represent all plays that occurred during at least a half of the football game, the plurality of symbols and the additional symbols representing the plays that occurred during the half such that each of the plays can be distinguished from the others of the plays.

20. The apparatus as claimed in claim 14, wherein the printing device is configured to render additional symbols on the substrate so that the plurality of symbols and the additional symbols together represent all plays that occurred during the entire football game, the plurality of symbols and the additional symbols representing the plays that occurred during the football game such that each of the plays can be distinguished from the others of the plays.

21. The apparatus as claimed in claim 14, wherein the printing device is configured to render the plurality of symbols on the substrate such that at least one player is identified on the substrate that was involved in each of the at least two plays.

22. The apparatus as claimed in claim 14, wherein the printing device is configured to render the plurality of symbols on the substrate such that at least one player is identified on the substrate that was responsible for moving the football on the football field during each of the at least two plays.

23. The apparatus as claimed in claim 14, wherein the printing device is configured to render the plurality of symbols as a plurality of line segments, each of the plurality of line segments representing a corresponding one of the at least two plays.

24. The apparatus as claimed in claim 23, wherein the printing device is configured to render the plurality of line segments on the substrate so that the plurality of line segments are joined end-to-end to form a drive line representing the drive.

25. The apparatus as claimed in claim 23, wherein the printing device is configured to render different types of line segments on the substrate to represent different types of plays.

26. The apparatus as claimed in claim 14, wherein the printing device is configured to render additional symbols on the substrate that indicate results, if any, of each of the at least two plays.

27. A computer-implemented method for rendering a diagram representing a football game between two teams, comprising a step of:
(a) in response to information input to a processor regarding at least two plays in a drive by one of the two teams, rendering a plurality of symbols on at least one of a display and a substrate of a printing device, the plurality of symbols being rendered along a path representing at least a portion of the drive by the one of the two teams, and representing the at least two plays such that each of the at least two plays can be distinguished from the other of the at least two plays.

28. The computer-implemented method as claimed in claim 27, wherein:
the method further includes a step of (b) rendering a plurality of parallel lines on the at least one of the display and the substrate of the printing device, the plurality of parallel lines representing marked yard lines of a football field on which the football game was or is being played, and
the step (a) includes a step of rendering the plurality of symbols on the at least one of the display and the substrate of the printing device such that positions of the plurality of symbols with respect to the plurality of parallel lines correspond to yard lines of the football field at which each of the at least two plays began and ended.

29. The computer-implemented method as claimed in claim 27, wherein the step (a) includes a step of rendering a plurality of line segments on the at least one of the display and the substrate of the printing device, each of the plurality of line segments representing a corresponding one of the at least two plays and extending between positions on the at least one of the display and the substrate of the printing device, with respect to the plurality of parallel lines, corresponding to yard lines on the football field at which the one of the at least two plays began and ended.

30. The computer-implemented method as claimed in claim 27, wherein the step (a) includes a step of rendering different types of symbols on the at least one of the display and the substrate of the printing device to represent different types of plays thereon.

31. The computer-implemented method as claimed in claim 27, further including a step of:
(b) rendering additional symbols on the at least one of the display and the substrate of the printing device so that the plurality of symbols and the additional symbols together represent all plays that occurred during at least a quarter of the football game, the plurality of symbols and the additional symbols representing the plays that occurred during the quarter such that each of the plays can be distinguished from the others of the plays.

32. The computer-implemented method as claimed in claim 27, further including a step of:
(b) rendering additional symbols on the at least one of the display and the substrate of the printing device so that the plurality of symbols and the additional symbols together represent all plays that occurred during at least a half of the football game, the plurality of symbols and the additional symbols representing the plays that occurred during the half such that each of the plays can be distinguished from the others of the plays.

33. The computer-implemented method as claimed in claim 27, further including a step of:
(b) rendering additional symbols on the at least one of the display and the substrate of the printing device so that the plurality of symbols and the additional symbols together represent all plays that occurred during the entire football game, the plurality of symbols and the additional symbols representing the plays that occurred during the football game such that each of the plays can be distinguished from the others of the plays.

34. The computer-implemented method as claimed in claim 27, wherein the step (a) includes a step of:
(a1) rendering the plurality of symbols on the at least one of the display and the substrate of the printing device so as to identify at least one player that was involved in each of the at least two plays.

35. The computer-implemented method as claimed in claim 27, wherein the step (a) includes a step of rendering the plurality of symbols on the at least one of the display and the substrate of the printing device so as to identify at least one player that was responsible for moving the football on the football field during each of the at least two plays.

36. The computer-implemented method as claimed in claim 27, wherein the step (a) includes a step of:
(a1) rendering a plurality of line segments on the at least one of the display and the substrate of the printing device, each of the plurality of line segments representing a corresponding one of the at least two plays.

37. The computer-implemented method as claimed in claim 36, wherein the step (a1) includes a step of joining the plurality of line segments end-to-end to form a drive line representing the drive.

38. The computer-implemented method as claimed in claim 36, wherein the step (a1) includes a step of rendering different types of line segments on the at least one of the display and the substrate of the printing device to represent different types of plays.

39. The computer-implemented method as claimed in claim 27, further including a step of:
(b) rendering additional symbols on the at least one of the display and the substrate of the printing device that indicate results, if any, of each of the at least two plays.

40. The computer-implemented method as claimed in claim 28, further including a step of:
(c) in response to a user identifying a location on the display, with respect to the plurality of parallel lines, corresponding to a location on the football field at which one of the at least two plays ended, displaying a user-input screen to a user that permits the user to input information to the processor regarding the one of the at least two plays.

41. A computer-readable medium for use with a processor, the medium having a plurality of instructions stored thereon which, when executed by the processor, cause the processor to perform a step of:
(a) in response to information input to the processor regarding at least two plays in a drive by a football team, causing a plurality of symbols to be rendered on at least one of a display and a substrate of a printing device, the plurality of symbols being rendered along a path representing at least a portion of the drive by the one of the two teams, and representing the at least two plays such that each of the at least two plays can be distinguished from the other of the at least two plays.

42. The computer-readable medium as claimed in claim 41, wherein:
the plurality of instructions stored on the computer-readable medium, when executed by the processor, cause the processor to perform a step of (b) causing a plurality of parallel lines to be rendered on the at least one of the display and the substrate of the printing device, the plurality of parallel lines representing marked yard lines of a football field on which the football game was or is being played, and
the step (a) includes a step of causing the plurality of symbols to be rendered on the at least one of the display and the substrate of the printing device such that positions of the plurality of symbols with respect to the plurality of parallel lines correspond to yard lines of the football field at which each of the at least two plays began and ended.

43. The computer-readable medium as claimed in claim 42, wherein the step (a) includes a step of:
causing a plurality of line segments to be rendered on the at least one of the display and the substrate of the printing device, each of the plurality of line segments representing a corresponding one of the at least two plays and extending between positions on the at least one of the display and the substrate of the printing device, with respect to the plurality of parallel lines, corresponding to yard lines on the football field at which the one of the at least two plays began and ended.

44. The computer-readable medium as claimed in claim 41, wherein the step (a) includes a step of:
causing different types of symbols to be rendered on the at least one of the display and the substrate of the printing device to represent different types of plays thereon.

45. The computer-readable medium as claimed in claim 41, wherein the plurality of instructions stored on the computer-readable medium, when executed by the processor, cause the processor to perform a step of:
(b) causing additional symbols to be rendered on the at least one of the display and the substrate of the printing device so that the plurality of symbols and the additional symbols together represent all plays that occurred during at least a quarter of the football game, the plurality of symbols and the additional symbols representing the plays that occurred during the quarter such that each of the plays can be distinguished from the others of the plays.

46. The computer-readable medium as claimed in claim 41, wherein the plurality of instructions stored on the computer-readable medium, when executed by the processor, cause the processor to perform a step of:
(b) causing additional symbols to be rendered on the at least one of the display and the substrate of the printing device so that the plurality of symbols and the additional symbols together represent all plays that occurred during at least a half of the football game, the plurality of symbols and the additional symbols representing the plays that occurred during the half such that each of the plays can be distinguished from the others of the plays.

47. The computer-readable medium as claimed in claim 41, wherein the plurality of instructions stored on the computer-readable medium, when executed by the processor, cause the processor to perform a step of:
(b) causing additional symbols to be rendered on the at least one of the display and the substrate of the printing device so that the plurality of symbols and the additional symbols together represent all plays that occurred during the entire football game, the plurality of symbols and the additional symbols representing the plays that occurred during the football game such that each of the plays can be distinguished from the others of the plays.

48. The computer-readable medium as claimed in claim 41, wherein the step (a) includes a step of causing the plurality of symbols to be rendered on the at least one of the display and the substrate of the printing device so as to identify at least one player that was involved in each of the at least two plays.

49. The computer-readable medium as claimed in claim 41, wherein the step (a) includes a step of causing the plurality of symbols to be rendered on the at least one of the display and the substrate of the printing device so as to identify at least one player that was responsible for moving the football on the football field during each of the at least two plays.

50. The computer-readable medium as claimed in claim 41, wherein the step (a) includes a step of:
(a1) causing a plurality of line segments to be rendered on the at least one of the display and the substrate of the printing device, each of the plurality of line segments representing a corresponding one of the at least two plays.

51. The computer-readable medium as claimed in claim 50, wherein the step (a1) includes a step of causing the plurality of line segments to be joined end-to-end to form a drive line representing the drive.

52. The computer-readable medium as claimed in claim 50, wherein the step (a1) includes a step of causing different types of line segments to be rendered on the at least one of the display and the substrate of the printing device to represent different types of plays.

53. The computer-readable medium as claimed in claim 41, wherein the plurality of instructions stored on the computer-readable medium, when executed by the processor, cause the processor to perform a step of:
(b) causing additional symbols to be rendered on the at least one of the display and the substrate of the printing device that indicate results, if any, of each of the at least two plays.

54. The computer-readable medium as claimed in claim 42, wherein the plurality of instructions stored on the computer-readable medium, when executed by the processor, cause the processor to perform a step of:
(c) in response to a user identifying a location on the display, with respect to the plurality of lines, corresponding to a location on the football field at which one of the at least two plays ended, displaying a user-input screen to a user that permits the user to input information to the processor regarding the one of the at least two plays.

55. An apparatus for rendering a diagram representing a football game between two teams, comprising:
means, responsive to information input by a user regarding at least two plays in a drive by one of the two teams, for rendering a plurality of symbols on at least one of a display and a substrate of a printing device, the plurality of symbols being rendered along a path representing at least a portion of the drive by the one of the two teams; and
means for representing the at least two plays such that each of the at least two plays can be distinguished from the other of the at least two plays.

56. The apparatus as claimed in claim 55, further including means for inputting the information regarding the at least two plays.

57. A computer-implemented method for rendering a diagram representing a football game between two teams, comprising steps of:
(a) rendering a single representation of a football field on which the game was played on at least one of a display and a substrate of a printing device; and
(b) in response to information input by a user regarding drives of the football game, rendering a plurality of symbols on the at least one of the display and the substrate of the printing device within the single representation of the football field that represent all drives that occurred during at least a half of the football game.

58. The computer-implemented method as claimed in claim 57, wherein the step (b) includes a step of rendering the plurality of symbols on the at least one of the display and the substrate of the printing device so as to represent all drives that occurred during the entire football game.

59. The computer-implemented method as claimed in claim 57, wherein the step (a) includes a step of:
(a1) rendering an altered representation of the football field such that a ratio of a width of the representation of the football field to a length of the representation of the football field is greater than a ratio of a width of the football field on which the football game was played to a length of the football field on which the game was played.

60. The computer-implemented method as claimed in claim 59, wherein the step (a1) includes a step of rendering the representation of the football field such that its width is at least as great as its length.
